(19) United States
(12) Patent Application Publication
(10) Pub. No.: US 2023/0239301 A1
(43) Pub. Date: Jul. 27, 2023

(54) METHODS AND APPARATUS FOR SHARING CLOUD RESOURCES IN A MULTI-TENANT SYSTEM USING SELF-REFERENCING ADAPTER

(71) Applicant: VMware, Inc., Palo Alto, CA (US)

(72) Inventors: Dimitar Ivanov, Sofia (BG); Ilia Pantchev, Sofia (BG); Ina Uzunova, Sofia (BG); Stoyan Genchev, Sofia (BG); Igor Stoyanov, Sofia (BG)

(21) Appl. No.: 17/581,185

(22) Filed: Jan. 21, 2022

(51) Int. Cl. H04L 9/40

(52) U.S. Cl. CPC H04L 63/102; H04L 63/20

(57) ABSTRACT

Methods, apparatus, systems, and articles of manufacture are disclosed to provision cloud infrastructure resources in a multi-tenant system using a self-referencing adapter, the apparatus comprising: provisioning circuitry to, in response to a first request from a tenant to access cloud infrastructure resources, determine a type of a cloud account, cloud provider interface circuitry to, in response to the type of the cloud account being a cloud provider interface type, access service-provider-credentials, the cloud provider interface circuitry to: retrieve a first access token based on the service-provider-credentials, submit a second request for the cloud infrastructure resources to a first cloud provider, the second request corresponding to the tenant impersonating the service provider based on the first access token.

### FIELD OF THE DISCLOSURE

This disclosure relates generally to cloud computing and, more particularly, to methods and apparatus for sharing cloud resources in a multi-tenant system using self-referencing adapter.

### BACKGROUND

Virtualizing computer systems provides benefits such as the ability to execute multiple computer systems on a single hardware computer, replicating computer systems, moving computer systems among multiple hardware computers, and so forth. “Infrastructure-as-a-Service” (also commonly referred to as “IaaS”) generally describes a suite of technologies provided by a service provider as an integrated solution to allow for elastic creation of a virtualized, networked, and pooled computing platform (sometimes referred to as a “cloud computing platform”). Enterprises may use IaaS as a business-internal organizational cloud computing platform (sometimes referred to as a “private cloud”) that gives an application developer access to infrastructure resources, such as virtualized servers, storage, and networking resources. By providing ready access to the hardware resources required to run an application, the cloud computing platform enables developers to build, deploy, and manage the lifecycle of a web application (or any other type of networked application) at a greater scale and at a faster pace than ever before.

Cloud computing environments may be composed of many processing units (e.g., servers). The processing units may be installed in standardized frames, known as racks, which provide efficient use of floor space by allowing the processing units to be stacked vertically. The racks may additionally include other components of a cloud computing environment such as storage devices, networking devices (e.g., switches), etc.

### BRIEF DESCRIPTION OF THE DRAWINGS

FIG. 1 is an illustration of a virtual server rack to implement a virtual cloud computing environment offered by a cloud provider.

FIG. 2 is an example network-level environment of multiple cloud providers in communication with multiple tenants of a service provider via a network.

FIG. 3 is a block diagram of example cloud provider circuitry.

FIGS. 4 and 5 illustrate the service provider of FIG. 2 in communication with a tenant based on a cloud provider database.

FIG. 6 is an example service provider with a first datacenter provisioned for a first tenant and a second datacenter provisioned for a second tenant.

FIG. 7 is the example cloud provider hub circuitry of FIG. 3 indicating the service provider and the two tenants of FIG. 6.

FIG. 8 is the example service provider adding a cloud zone to the cloud account in the cloud provider interface.

FIG. 9 is the example service provider generating a first project for the first tenant, and a second project for the second tenant.

FIG. 10 is an example tenant of FIG. 2 generating a cloud provider interface cloud account.

FIG. 11 is an example enumeration process which relates the cloud infrastructure resources selected by the service provider into cloud infrastructure resources useable by a tenant.

FIG. 12 is an example tenant of FIG. 2 which can generate a project and provision a cloud zone to the project.

FIGS. 13-14 are flowcharts representative of example machine readable instructions and/or example operations that may be executed by example processor circuitry to implement the cloud provider circuitry of FIG. 3.

FIG. 15 is a block diagram of an example processing platform including processor circuitry structured to execute the example machine readable instructions and/or the example operations of FIGS. 13-14 to implement the cloud provider circuitry of FIG. 3.

FIG. 16 is a block diagram of an example implementation of the processor circuitry of FIG. 15.

FIG. 17 is a block diagram of another example implementation of the processor circuitry of FIG. 15.

FIG. 18 is a block diagram of an example software distribution platform (e.g., one or more servers) to distribute software (e.g., software corresponding to the example machine readable instructions of FIGS. 13-14) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. As used herein, connection references (e.g., attached, coupled, connected, and joined) may include intermediate members between the elements referenced by the connection reference. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Cloud computing is based on the deployment of many physical resources across a network, virtualizing the physical resources into virtual resources, and provisioning the virtual resources to perform cloud computing services and applications. In some instances, a virtual machine is generated based on a compilation of the virtual resources in which the virtual resources are based on the virtualization of corresponding physical resources. A virtual machine is a software computer that, like a physical computer, runs an operating system and applications. An operating system installed on a virtual machine is referred to as a guest operating system. Because each virtual machine is an isolated computing environment, virtual machines (VMs) can be used as desktop or workstation environments, as testing environments, to consolidate server applications, etc. Virtual machines can run on hosts or clusters. The same host can run a plurality of VMs, for example. Virtual cloud computing uses networks of remote servers, computers and/or computer programs to manage access to centralized resources and/or services, to store, manage, and/or process data. Virtual cloud computing enables businesses and large organizations to scale up information technology (IT) requirements as demand or business needs increase. Virtual cloud computing relies on sharing resources to achieve coherence and economies of scale over a network. In some example cloud computing environments, an organization may store sensitive client data in-house on a private cloud application, but interconnect to a business intelligence application provided on a public cloud software service. In such examples, a cloud may extend capabilities of an enterprise, for example, to deliver a specific business service through the addition of externally available public cloud services. In some examples, cloud computing permits multiple users to access a single server to retrieve and/or update data without purchasing licenses for different applications.

Prior to cloud computing, as resources and data increased based on increased business needs or demands, computing systems required the addition of significantly more data storage infrastructure. Virtual cloud computing accommodates increases in workflows and data storage demands without significant efforts of adding more hardware infrastructure. For example, businesses may scale data storage allocation in a cloud without purchasing additional infrastructure.

Cloud computing comprises a plurality of key characteristics. First, cloud computing allows software to access application programmable interfaces (APIs) that enable machines to interact with cloud software in the same way that a traditional user interface (e.g., a computer desktop) facilitates interaction between humans and computers. Second, cloud computing enables businesses or large organizations to allocate expenses on an operational basis (e.g., on a per-use basis) rather than a capital basis (e.g., equipment purchases). Costs of operating a business using, for example, cloud computing, are not significantly based on purchasing fixed assets but are instead more based on maintenance of existing infrastructure. Third, cloud computing enables convenient maintenance procedures because computing applications are not installed on individual users' physical computers but are instead installed at one or more servers forming the cloud service. As such, software can be accessed and maintained from different places (e.g., from an example virtual cloud).

Information technology (IT) is the application of computers and telecommunications equipment to store, retrieve, transmit and/or manipulate data, often in the context of a business or other enterprise. For example, databases store large amounts of data to enable quick and accurate information storage and retrieval. IT service management refers to the activities (e.g., directed by policies, organized and structured in processes and supporting procedures) that are performed by an organization or part of an organization to plan, deliver, operate and control IT services that meet the needs of customers. IT management may, for example, be performed by an IT service provider through a mix of people, processes, and information technology. In some examples, an IT system administrator is a person responsible for the upkeep, configuration, and reliable operation of computer systems; especially multi-user computers, such as servers that seek to ensure uptime, performance, resources, and security of computers meet user needs. For example, an IT system administrator may acquire, install and/or upgrade computer components and software, provide routine automation, maintain security policies, troubleshoot technical issues, and provide assistance to users in an IT network. An enlarged user group and a large number of service requests can quickly overload system administrators and prevent immediate troubleshooting and service provisioning.

Cloud provisioning is the allocation of cloud provider resources to a customer when a cloud provider accepts a request from a customer. For example, the cloud provider creates a corresponding number of virtual machines and allocates resources (e.g., application servers, load balancers, network storage, databases, firewalls, IP addresses, virtual or local area networks, etc.) to support application operation. In some examples, a virtual machine is an emulation of a particular computer system that operates based on a particular computer architecture, while functioning as a real or hypothetical computer. Virtual machine implementations may involve specialized hardware, software, or a combination of both. Example virtual machines allow multiple operating system environments to co-exist on the same primary hard drive and support application provisioning. Before example virtual machines and/or resources are provisioned to users, cloud operators and/or administrators determine which virtual machines and/or resources should be provisioned to support applications requested by users.

Infrastructure-as-a-Service (also commonly referred to as IaaS) generally describes a suite of technologies provided by a service provider as an integrated solution to allow for elastic creation of a virtualized, networked, and pooled computing platform (sometimes referred to as a “cloud computing platform”). Enterprises may use IaaS as a business-internal organizational cloud computing platform that gives an application developer access to infrastructure resources, such as virtualized servers, storage, and networking resources. By providing ready access to the hardware resources required to run an application, the cloud computing platform enables developers to build, deploy, and manage projects at a greater scale and at a faster pace than ever before.

Examples disclosed herein can be used with one or more different types of virtualization environments. Three example types of virtualization environments are: full virtualization, paravirtualization, and operating system (OS) virtualization. Full virtualization, as used herein, is a virtualization environment in which hardware resources are managed by a hypervisor to provide virtual hardware resources to a virtual machine (VM). In a full virtualization environment, the VMs do not have access to the underlying hardware resources. In a typical full virtualization, a host OS with embedded hypervisor (e.g., a VMWARE® ESXI® hypervisor, etc.) is installed on the server hardware. VMs including virtual hardware resources are then deployed on the hypervisor. A guest OS is installed in the VM. The hypervisor manages the association between the hardware resources of the server hardware and the virtual resources allocated to the VMs (e.g., associating physical random-access memory (RAM) with virtual RAM, etc.). Typically, in full virtualization, the VM and the guest OS have no visibility and/or access to the hardware resources of the underlying server. Additionally, in full virtualization, a full guest OS is typically installed in the VM while a host OS is installed on the server hardware. Example virtualization environments include VMWARE® ESX® hypervisor, Microsoft HYPER-V® hypervisor, and Kernel Based Virtual Machine (KVM).

Paravirtualization, as used herein, is a virtualization environment in which hardware resources are managed by a hypervisor to provide virtual hardware resources to a VM, and guest Oss are also allowed to access some or all the underlying hardware resources of the server (e.g., without accessing an intermediate virtual hardware resource, etc.). In a typical paravirtualization system, a host OS (e.g., a Linux-based OS, etc.) is installed on the server hardware. A hypervisor (e.g., the XEN® hypervisor, etc.) executes on the host OS. VMs including virtual hardware resources are then deployed on the hypervisor. The hypervisor manages the association between the hardware resources of the server hardware and the virtual resources allocated to the VMs (e.g., associating RAM with virtual RAM, etc.). In paravirtualization, the guest OS installed in the VM is configured also to have direct access to some or all of the hardware resources of the server. For example, the guest OS can be precompiled with special drivers that allow the guest OS to access the hardware resources without passing through a virtual hardware layer. For example, a guest OS can be precompiled with drivers that allow the guest OS to access a sound card installed in the server hardware. Directly accessing the hardware (e.g., without accessing the virtual hardware resources of the VM, etc.) can be more efficient, can allow for performance of operations that are not supported by the VM and/or the hypervisor, etc.

OS virtualization is also referred to herein as container virtualization. As used herein, OS virtualization refers to a system in which processes are isolated in an OS. In a typical OS virtualization system, a host OS is installed on the server hardware. Alternatively, the host OS can be installed in a VM of a full virtualization environment or a paravirtualization environment. The host OS of an OS virtualization system is configured (e.g., utilizing a customized kernel, etc.) to provide isolation and resource management for processes that execute within the host OS (e.g., applications that execute on the host OS, etc.). The isolation of the processes is known as a container. Thus, a process executes within a container that isolates the process from other processes executing on the host OS. Thus, OS virtualization provides isolation and resource management capabilities without the resource overhead utilized by a full virtualization environment or a paravirtualization environment. Example OS virtualization environments include Linux Containers LXC and LXD, the DOCKER™ container platform, the OPENVZ™ container platform, etc.

In some examples, a data center (or pool of linked data centers) can include multiple different virtualization environments. For example, a data center can include hardware resources that are managed by a full virtualization environment, a paravirtualization environment, an OS virtualization environment, etc., and/or a combination thereof. In such a data center, a workload can be deployed to any of the virtualization environments. In some examples, techniques to monitor both physical and virtual infrastructure, provide visibility into the virtual infrastructure (e.g., VMs, virtual storage, virtual or virtualized networks and their control/management counterparts, etc.) and the physical infrastructure (e.g., servers, physical storage, network switches, etc.).

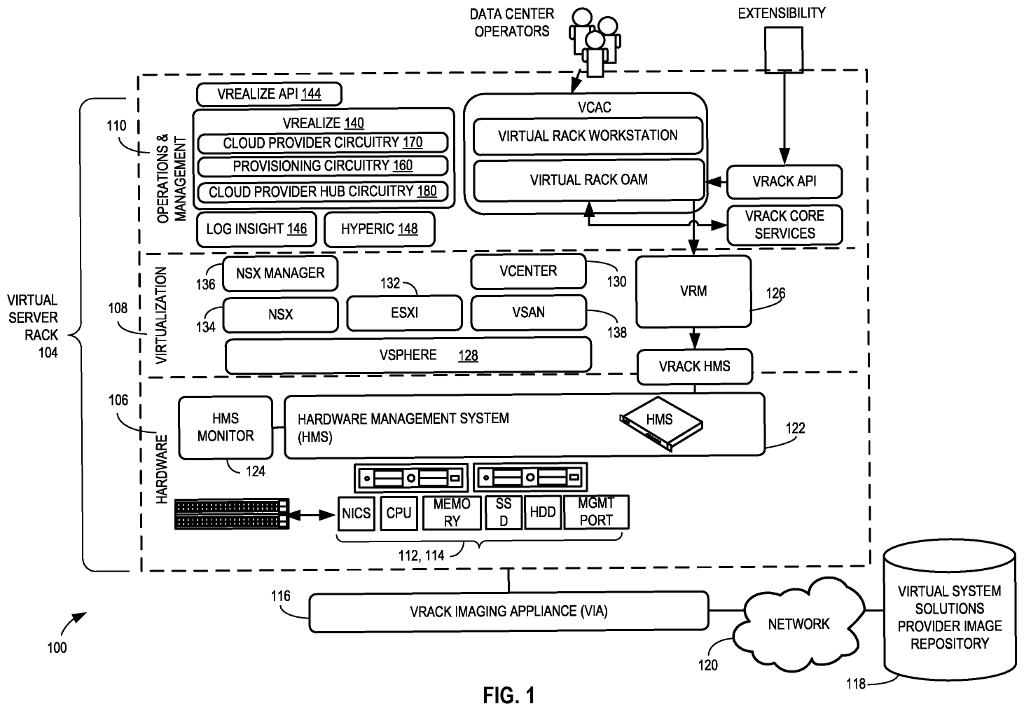

FIG. 1 is an example architecture 100 in which an example virtual imaging appliance (VIA) 116 is utilized to configure and deploy an example virtual server rack 104. The example architecture 100 of FIG. 1 includes a hardware layer 106, a virtualization layer 108, and an operations and management (OAM) component 110. In the illustrated example, the hardware layer 106, the virtualization layer 108, and the operations and management (OAM) component 110 are part of the example virtual server rack 104. The virtual server rack 104 of the illustrated example is based on one or more example physical racks.

Example physical racks are a combination of computing hardware and installed software that may be utilized by a customer to create and/or add to a virtual computing environment. For example, the physical racks may include processing units (e.g., multiple blade servers), network switches to interconnect the processing units and to connect the physical racks with other computing units (e.g., other physical racks in a network environment such as a cloud computing environment), and/or data storage units (e.g., network attached storage, storage area network hardware, etc.). The example physical racks are prepared by the system integrator in a partially configured state to enable the computing devices to be rapidly deployed at a customer location (e.g., in less than 2 hours). For example, the system integrator may install operating systems, drivers, operations software, management software, etc. The installed components may be configured with some system details (e.g., system details to facilitate intercommunication between the components of two or more physical racks) and/or may be prepared with software to collect further information from the customer when the virtual server rack is installed and first powered on by the customer.

The example virtual server rack 104 is configured to configure example physical hardware resources 112, 114 (e.g., physical hardware resources of the one or more physical racks), to virtualize the physical hardware resources 112, 114 into virtual resources, to provision virtual resources for use in providing cloud-based services, and to maintain the physical hardware resources 112, 114 and the virtual resources. The example architecture 100 includes an example virtual imaging appliance (VIA) 116 that communicates with the hardware layer 106 to store operating system (OS) and software images in memory of the hardware layer 106 for use in initializing physical resources needed to configure the virtual server rack 104. In the illustrated example, the VIA 116 retrieves the OS and software images from a virtual system provider image repository 118 via an example network 120 (e.g., the Internet). For example, the VIA 116 is to configure new physical racks for use as virtual server racks (e.g., the virtual server rack 104). That is, whenever a system integrator wishes to configure new hardware (e.g., a new physical rack) for use as a virtual server rack, the system integrator connects the VIA 116 to the new hardware, and the VIA 116 communicates with the virtual system provider image repository 118 to retrieve OS and/or software images needed to configure the new hardware for use as a virtual server rack. In the illustrated example, the OS and/or software images located in the virtual system provider image repository 118 are configured to provide the system integrator with flexibility in selecting to obtain hardware from any of a number of hardware manufacturers. As such, end users can source hardware from multiple hardware manufacturers without needing to develop custom software solutions for each hardware manufacturer. Further details of the example VIA 116 are disclosed in U.S. Patent Application Publication No. 2016/0013974, filed on Jun. 26, 2015, and titled “Methods and Apparatus for Rack Deployments for Virtual Computing Environments,” which is hereby incorporated herein by reference in its entirety.

The example hardware layer 106 of FIG. 1 includes an example hardware management system (HMS) 122 that interfaces with the physical hardware resources 112, 114 (e.g., processors, network interface cards, servers, switches, storage devices, peripherals, power supplies, etc.). The HMS 122 is configured to manage individual hardware nodes such as different ones of the physical hardware resources 112, 114. For example, managing of the hardware nodes involves discovering nodes, bootstrapping nodes, resetting nodes, processing hardware events (e.g., alarms, sensor data threshold triggers) and state changes, exposing hardware events and state changes to other resources and a stack of the virtual server rack 104 in a hardware-independent manner. The HMS 122 also supports rack-level boot-up sequencing of the physical hardware resources 112, 114 and provides services such as secure resets, remote resets, and/or hard resets of the physical hardware resources 112, 114.

In the illustrated example of FIG. 1, the hardware layer 106 includes an example HMS monitor 124 to monitor the operational status and health of the HMS 122. The example HMS monitor 124 is an external entity outside of the context of the HMS 122 that detects and remediates failures in the HMS 122. That is, the HMS monitor 124 is a process that runs outside the HMS daemon to monitor the daemon. For example, the HMS monitor 124 can run alongside the HMS 122 in the same management switch as the HMS 122.

The example virtualization layer 108 includes an example virtual rack manager (VRM) 126. The example VRM 126 communicates with the HMS 122 to manage the physical hardware resources 112, 114. The example VRM 126 creates the example virtual server rack 104 out of underlying physical hardware resources 112, 114 that may span one or more physical racks (or smaller units such as a hyper-appliance or half rack) and handles physical management of those resources. The example VRM 126 uses the virtual server rack 104 as a basis of aggregation to create and provide operational views, handle fault domains, and scale to accommodate workload profiles. The example VRM 126 keeps track of available capacity in the virtual server rack 104, maintains a view of a logical pool of virtual resources throughout the SDDC life-cycle, and translates logical resource provisioning to allocation of physical hardware resources 112, 114. The example VRM 126 interfaces with components of a virtual system solutions provider, such as an example VMware vSphere® virtualization infrastructure components suite 128, an example VMware vCenter® virtual infrastructure server 130, an example ESXi™ hypervisor component 132, an example VMware NSX® network virtualization platform 134 (e.g., a network virtualization component or a network virtualizer), an example VMware NSX® network virtualization manager 136, and an example VMware vSAN™ network data storage virtualization component 138 (e.g., a network data storage virtualizer). In the illustrated example, the VRM 126 communicates with these components to manage and present the logical view of underlying resources such as hosts and clusters. The example VRM 126 also uses the logical view for orchestration and provisioning of workloads.

The VMware vSphere® virtualization infrastructure components suite 128 of the illustrated example is a collection of components to setup and manage a virtual infrastructure of servers, networks, and other resources. Example components of the VMware vSphere® virtualization infrastructure components suite 128 include the example VMware vCenter® virtual infrastructure server 130 and the example ESXi™ hypervisor component 132.

The example VMware vCenter® virtual infrastructure server 130 provides centralized management of a virtualization infrastructure (e.g., a VMware vSphere® virtualization infrastructure). For example, the VMware vCenter® virtual infrastructure server 130 provides centralized management of virtualized hosts and virtual machines from a single console to provide IT administrators with access to inspect and manage configurations of components of the virtual infrastructure.

The example ESXi™ hypervisor component 132 is a hypervisor that is installed and runs on servers in the example physical hardware resources 112, 114 to enable the servers to be partitioned into multiple logical servers to create virtual machines.

The example VMware NSX® network virtualization platform 134 (e.g., a network virtualization component or a network virtualizer) virtualizes network resources such as physical hardware switches to provide software-based virtual networks. The example VMware NSX® network virtualization platform 134 enables treating physical network resources (e.g., switches) as a pool of transport capacity. In some examples, the VMware NSX® network virtualization platform 134 also provides network and security services to virtual machines with a policy driven approach.

The example VMware NSX® network virtualization manager 136 manages virtualized network resources such as physical hardware switches to provide software-based virtual networks. In the illustrated example, the VMware NSX® network virtualization manager 136 is a centralized management component of the VMware NSX® network virtualization platform 134 and runs as a virtual appliance on an ESXi host. In the illustrated example, a VMware NSX® network virtualization manager 136 manages a single vCenter server environment implemented using the VMware vCenter® virtual infrastructure server 130. In the illustrated example, the VMware NSX® network virtualization manager 136 is in communication with the VMware vCenter® virtual infrastructure server 130, the ESXi™ hypervisor component 132, and the VMware NSX® network virtualization platform 134.

The example VMware vSAN™ network data storage virtualization component 138 is software-defined storage for use in connection with virtualized environments implemented using the VMware vSphere® virtualization infrastructure components suite 128. The example VMware vSAN™ network data storage virtualization component clusters server-attached hard disk drives (HDDs) and solid state drives (SSDs) to create a shared datastore for use as virtual storage resources in virtual environments.

Although the example VMware vSphere® virtualization infrastructure components suite 128, the example VMware vCenter® virtual infrastructure server 130, the example ESXi™ hypervisor component 132, the example VMware NSX® network virtualization platform 134, the example VMware NSX® network virtualization manager 136, and the example VMware vSAN™ network data storage virtualization component 138 are shown in the illustrated example as implemented using products developed and sold by VMware, Inc., some or all of such components may alternatively be supplied by components with the same or similar features developed and sold by other virtualization component developers.

The virtualization layer 108 of the illustrated example, and its associated components are configured to run virtual machines. However, in other examples, the virtualization layer 108 may additionally or alternatively be configured to run containers. A virtual machine is a data computer node that operates with its own guest operating system on a host using resources of the host virtualized by virtualization software. A container is a data computer node that runs on top of a host operating system without the need for a hypervisor or separate operating system.

The virtual server rack 104 of the illustrated example enables abstracting the physical hardware resources 112, 114. In some examples, the virtual server rack 104 includes a set of physical units (e.g., one or more racks) with each unit including physical hardware resources 112, 114 such as server nodes (e.g., compute+storage+network links), network switches, and, optionally, separate storage units. From a user perspective, the example virtual server rack 104 is an aggregated pool of logic resources exposed as one or more vCenter ESXi™ clusters along with a logical storage pool and network connectivity. In examples disclosed herein, a cluster is a server group in a virtual environment. For example, a vCenter ESXi™ cluster is a group of physical servers in the physical hardware resources 112, 114 that run ESXi™ hypervisors (developed and sold by VMware, Inc.) to virtualize processor, memory, storage, and networking resources into logical resources to run multiple virtual machines that run operating systems and applications as if those operating systems and applications were running on physical hardware without an intermediate virtualization layer.

In the illustrated example, the example OAM component 110 is an extension of a VMware vCloud® Automation Center (VCAC) that relies on the VCAC functionality and also leverages utilities such as a cloud management platform (e.g., a vRealize Automation® cloud management platform) 140, Log Insight™ log management service 146, and Hyperic® application management service 148 to deliver a single point of SDDC operations and management. The example OAM component 110 is configured to provide different services such as heat-map service, capacity planner service, maintenance planner service, events and operational view service, and virtual rack application workloads manager service.

In the illustrated example, the vRealize Automation® cloud management platform 140 is a cloud management platform that can be used to build and manage a multi-vendor cloud infrastructure. The vRealize Automation® cloud management platform 140 provides a plurality of services that enable self-provisioning of virtual machines in private and public cloud environments, physical machines (install OEM images), applications, and IT services according to policies defined by administrators. For example, the vRealize Automation® cloud management platform 140 may include a cloud assembly service to create and deploy machines, applications, and services to a cloud infrastructure, a code stream service to provide a continuous integration and delivery tool for software, and a broker service to provide a user interface to non-administrative users to develop and build templates for the cloud infrastructure when administrators do not need full access for building and developing such templates. The example vRealize Automation® cloud management platform 140 may include a plurality of other services, not described herein, to facilitate building and managing the multi-vendor cloud infrastructure. In some examples, the example vRealize Automation® cloud management platform 140 may be offered as an on-premise (e.g., on-prem) software solution wherein the vRealize Automation® cloud management platform 140 is provided to an example customer to run on the customer servers and customer hardware. In other examples, the example vRealize Automation® cloud management platform 140 may be offered as a Software as a Service (e.g., SaaS) wherein at least one instance of the vRealize Automation® cloud management platform 140 is deployed on a cloud provider (e.g., Amazon Web Services).

In the illustrated example, a heat map service of the OAM component 110 exposes component health for hardware mapped to virtualization and application layers (e.g., to indicate good, warning, and critical statuses). The example heat map service also weighs real-time sensor data against offered service level agreements (SLAs) and may trigger some logical operations to make adjustments to ensure continued SLA.

In the illustrated example, the capacity planner service of the OAM component 110 checks against available resources and looks for potential bottlenecks before deployment of an application workload. The example capacity planner service also integrates additional rack units in the collection/stack when capacity is expanded.

In the illustrated example, the maintenance planner service of the OAM component 110 dynamically triggers a set of logical operations to relocate virtual machines (VMs) before starting maintenance on a hardware component to increase the likelihood of substantially little or no downtime. The example maintenance planner service of the OAM component 110 creates a snapshot of the existing state before starting maintenance on an application. The example maintenance planner service of the OAM component 110 automates software upgrade/maintenance by creating clones of machines, upgrading software on clones, pausing running machines, and attaching clones to a network. The example maintenance planner service of the OAM component 110 also performs rollbacks if upgrades are not successful.

In the illustrated example, an events and operational views service of the OAM component 110 provides a single dashboard for logs by feeding to a Log Insight™ log management service 146. The example events and operational views service of the OAM component 110 also correlates events from the heat map service against logs (e.g., a server starts to overheat, connections start to drop, lots of HTTP/503 from App servers). The example events and operational views service of the OAM component 110 also creates a business operations view (e.g., a top down view from Application Workloads=>Logical Resource View=>Physical Resource View). The example events and operational views service of the OAM component 110 also provides a logical operations view (e.g., a bottom up view from Physical resource view=>vCenter ESXi Cluster View=>VM's view).

In the illustrated example, the virtual rack application workloads manager service of the OAM component 110 uses vCAC and vCAC enterprise services to deploy applications to vSphere hosts. The example virtual rack application workloads manager service of the OAM component 110 uses data from the heat map service, the capacity planner service, the maintenance planner service, and the events and operational views service to build intelligence to pick the best mix of applications on a host (e.g., not put all high CPU intensive apps on one host). The example virtual rack application workloads manager service of the OAM component 110 optimizes applications and virtual storage area network (vSAN) arrays to have high data resiliency and the best possible performance achievable at the same time.

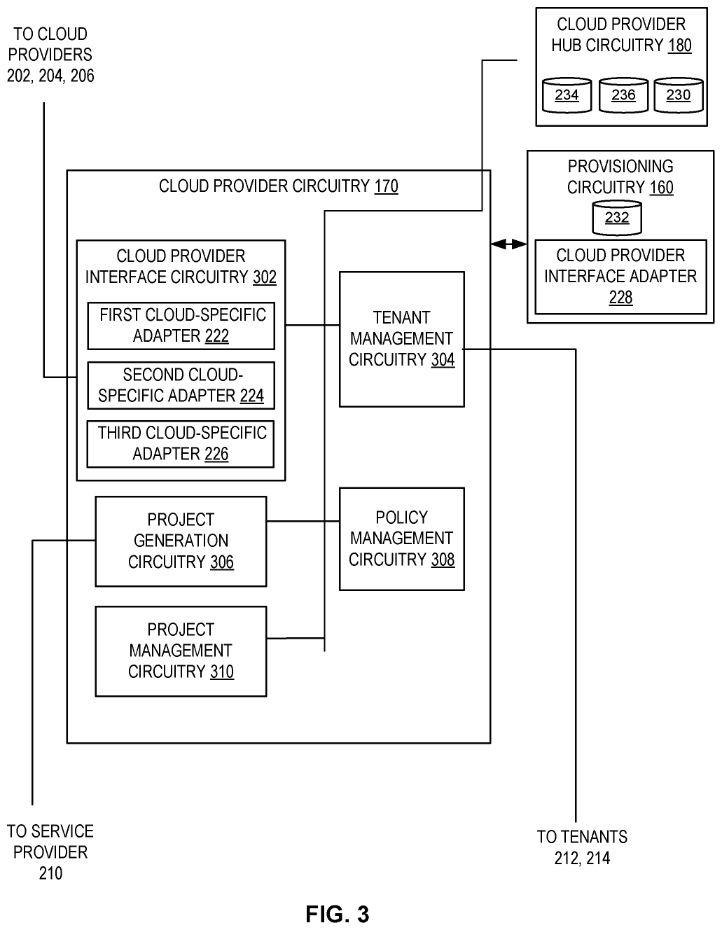

In the illustrated example of FIG. 1, the architecture 100 includes example cloud provider circuitry 170. The example cloud provider circuitry 170 is a component of the vRealize Automation® cloud management platform 140. The example cloud provider circuitry 170 is in communication with example provisioning circuitry 160 (e.g., a provisioning engine), example cloud provider hub circuitry 180, and the example vRealize Automation® cloud management platform application programming interface (API) 144 (e.g., vRealize API 144). The example cloud provider circuitry 170 allows tenants of a service provider to access cloud infrastructure resources from cloud providers. For example, the example cloud provider circuitry 170 is implemented by an application (e.g., executed by processor circuitry, etc.) that enables an administrator (e.g., a service provider) to select cloud providers and allow a first tenant to access the cloud infrastructure resources of the cloud providers through the service provider. The example provisioning circuitry 160 is to provision the cloud infrastructure resources that the tenant decides to deploy. The example cloud provider circuitry 170 is described in further detail below in connection with FIG. 3.

Although the example VCAC, the example vRealize Automation® cloud management platform 140, the example Log Insight™ log management service 146, the example Hyperic® application management service 148, and the example cloud provider circuitry 170 are shown in the illustrated example as implemented using products developed and sold by VMware, Inc., some or all of such components may alternatively be supplied by components with the same or similar features developed and sold by other virtualization component developers. For example, the utilities leveraged by the cloud automation center may be any type of cloud computing platform and/or cloud management platform that delivers and/or provides management of the virtual and physical components of the architecture 100.

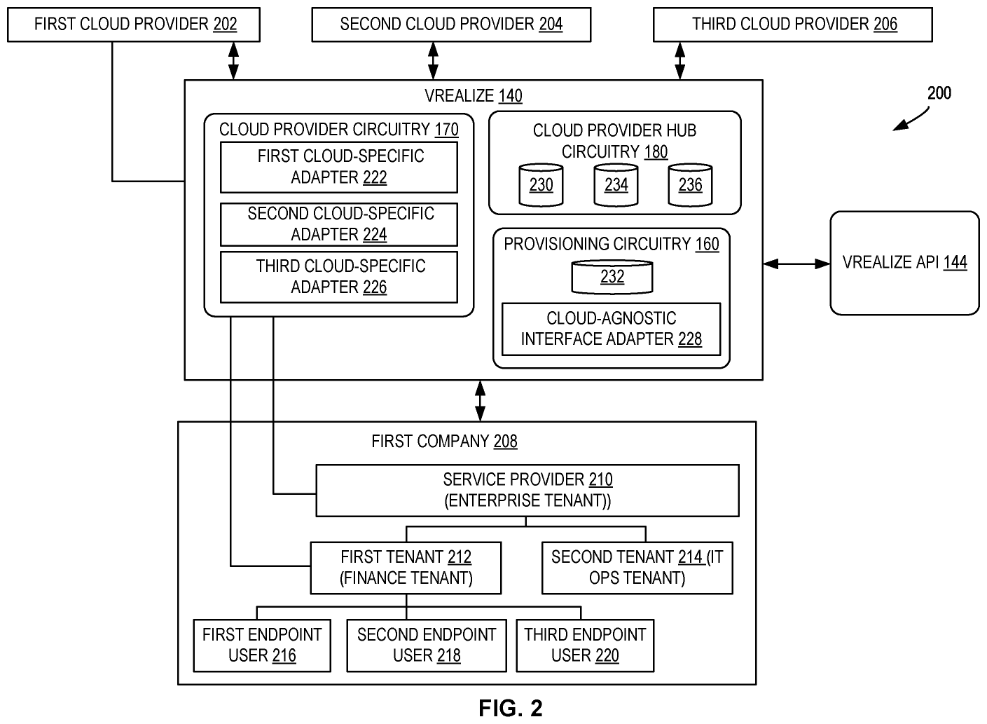

FIG. 2 is a network level environment 200 illustrating an example first cloud provider 202, an example second cloud provider 204, and an example third cloud provider 206 offering cloud infrastructure resources to an example first company 208. The example first company 208 is in communication with a cloud infrastructure resources aggregator such as the vRealize Automation® cloud management platform 140, which is used to provision the cloud infrastructure resources from the example cloud providers (e.g., the first cloud provider 202, the second cloud provider 204, the third cloud provider 206, etc.).

The example first company 208 includes an example service provider 210, an example first tenant 212 (e.g., the finance tenant), and an example second tenant 214 (e.g., the information technology operations tenant). The example first tenant 212 includes an example first endpoint user device 216, an example second endpoint user device 218, and an example third endpoint user device 220. The example endpoint user devices 216, 218, 220 represent devices or computers used by people (users) (e.g., employed by or registered with the first tenant 212). However, examples disclosed herein may be implemented with any other numbers of tenants and/or endpoint users. In the example of FIG. 2, there is one company (e.g., the first company 208) in communication with the example vRealize Automation® cloud management platform 140. However, in other examples, any number of companies may be in communication with the example vRealize Automation® cloud management platform 140. In some examples, the example first company 208 is in communication with the example vRealize Automation® cloud management platform 140 by accessing the example vRealize Automation® cloud management platform API 144.

The example cloud providers (e.g., the first cloud provider 202, the second cloud provider 204, the third cloud provider 206, etc.) provide (e.g., offer) cloud infrastructure resources for provisioning. Examples of the cloud providers include VMware vSphere cloud provider, Microsoft Azure Cloud Service, Amazon Web Services (AWS), Google Cloud Platform, Alibaba Cloud, and VMware vCloud Director cloud service delivery platform, etc. In some examples, the vRealize Automation® cloud management platform 140 includes adapters to access (e.g., integrate with) the example cloud providers. For example, the vRealize Automation® cloud management platform 140 may include adapters for Microsoft Azure Cloud Services, Amazon Web Services, Google Cloud Platform, VMware vSphere cloud provider, Alibaba Cloud, and VMware vCloud Director cloud service delivery platform. The example cloud providers 202, 204, 206 use different methods of cloud provisioning. To interact with the cloud providers 202, 204, 206 using their respective cloud provisioning methods, the example vRealize Automation® cloud management platform 140 uses multiple different cloud provider-specific adapters for the individual cloud providers 202, 204, 206. The cloud provider-specific adapters are shown in FIG. 2 as an example first cloud-specific adapter 222, an example second cloud-specific adapter 224, and an example third cloud-specific adapter 226. The example first cloud-specific adapter 222 is configured to communicate with the first cloud provider 202, the example second cloud-specific adapter 224 is configured to communicate with the second cloud provider 204, and the example third cloud-specific adapter 226 is configured to communicate with the third cloud provider 206. For example, if the first cloud provider 202 is Amazon Web Services, the first cloud-specific adapter 222 is an Amazon Web Services adapter, because Amazon Web Services provisions virtual machines and cloud infrastructure resources differently than the second cloud provider 204 (e.g., Google Cloud Platform).

The example vRealize Automation® cloud management platform 140 also includes a cloud-agnostic interface adapter 228 (shown in FIG. 2), which is a self-referential adapter. As used herein, a self-referential adapter is an adapter that, in response to a provisioning request, references the example vRealize Automation® cloud management platform 140 and the example cloud provider circuitry 170, before referencing other cloud-specific adapters 222, 224, 226 for provisioning of cloud infrastructure resources. The example cloud-agnostic interface adapter 228 is a component of the example provisioning circuitry 160, and the example cloud-agnostic interface adapter 228 is unaware of example tenant management and example project management, as further described in connection with FIG. 3. The example cloud-agnostic interface adapter 228 is configured to allow example tenants 212, 214 to communicate with the example cloud provider circuitry 170 so that the example tenants 212, 214 can access the example cloud providers 202, 204, 206 via corresponding ones of the cloud-specific adapters 222, 224, 226. By allowing the example tenants 212, 214 access to the example cloud-agnostic interface adapter 228, the example service provider 210 allows the example tenants 212, 214 access to the first cloud provider 202, the second cloud provider 204, and the third cloud provider 206 via corresponding ones of the first cloud-specific adapter 222, the second cloud-specific adapter 224, and the third cloud-specific adapter 226 without requiring the tenants 212, 214 to possess information, software, or methods to directly communicate with the first cloud-specific adapter 222, the second cloud-specific adapter 224, and the third cloud-specific adapter 226.

The example vRealize Automation® cloud management platform 140 is provided with the example cloud provider hub circuitry 180 to manage and store account login credentials for different ones of the cloud providers 202, 204, 206 and to manage (e.g., generate, grant, expire, delete, etc.) access tokens (e.g., login tokens) for different ones of the tenants 212, 214 to access resources in different ones of the cloud providers 202, 204, 206. The example cloud provider hub circuitry 180 is provided with a cloud credential database 230 and separate tenant credential databases 234, 236. The example cloud credential database 230 is provided to store cloud provider account login credentials registered with different ones of the cloud providers 202, 204, 206. Using the cloud provider account login credentials, the example service provider 210, the example first tenant 212, and/or the example second tenant 214 can log into (e.g., sign-in to) the example cloud providers 202, 204, 206 and access cloud resources of the example cloud providers 202, 204, 206 without needing to create multiple different cloud provider account login credentials for each of the example service provider 210, the example first tenant 212, and the example second tenant 214 for each of the example cloud providers 202, 204, 206. For example, by storing a single set of credentials for the first cloud provider 202 in the cloud credential database 230, the example service provider 210, the example first tenant 212, and the example second tenant 214 do not need to create and manage their own separate cloud provider account login credentials to access the example first cloud provider 202. Instead, the example service provider 210, the example first tenant 212, and the example second tenant 214 share a single set of cloud provider account login credentials of the example service provider 210 to access the example first cloud provider 202. To use the cloud credential database 230 in this manner, the example service provider 210 has access to the first cloud-specific adapter 222, the second cloud-specific adapter 224, and the third cloud-specific adapter 226, and allows the example tenants 212, 214 to impersonate the service provider 210 by using the cloud credentials in the cloud credential database 230 and the cloud-agnostic interface adapter 228. By impersonating the service provider 210, the example tenants 212, 214 are able to request cloud infrastructure resources from the example cloud providers 202, 204, 206 through the cloud-agnostic interface adapter 228 based on the cloud provider account login credentials of the service provider 210. When such requests are made by the tenants 212, 214 to the cloud-agnostic interface adapter 228, the cloud-agnostic interface adapter 228 communicates with the cloud providers 202, 204, 206 via corresponding ones of the cloud-specific adapters 222, 224, 226.

The example tenant credential databases 234, 236 are provided in the example cloud provider hub circuitry 180 to store internal login credentials also referred to herein as tenant login credentials or enterprise login credentials. As used herein, internal login credentials are usernames and passwords that are used inside the example vRealize Automation® cloud management platform 140 between the different internal entities (e.g., the example service provider 210, the example tenants 212, 214). The example first tenant credential database 234 is to store a dummy account for the example tenants 212, 214. For example, the first tenant credential database 234 may store a finance@enterprise.com account, which allows the first tenant 212 (e.g., the finance tenant) to impersonate the example service provider 210. The example second tenant credential database 236 is to store usernames and passwords that the different endpoint users may use to login (e.g., sign-in) to the different endpoint user devices 216, 218, 220. For example, an account stored by the example first tenant credential database 234 for a tenant 212, 214 is referred to as a dummy account because the endpoint users of the example tenants 212, 214 may all access the dummy account, as there is no “finance user.”

In the example of FIG. 2, the first company 208 includes the example service provider 210 (e.g., enterprise tenant, datacenter tenant) which provisions the cloud infrastructure resources of the example cloud providers 202, 204, 206 for use by internal company groups (e.g., the example first tenant 212, the example second tenant 214). In some examples, the first company 208 is a large enterprise customer of the vRealize Automation® cloud management platform 140. The example first company 208 may be in any type of industry and use the example cloud provider circuitry 170 to access the vRealize Automation® cloud management platform 140 to use cloud resources of a cloud provider (e.g., such as the first cloud provider 202) for internal and external teams of the first company 208. For example, the first company 208 may be primarily a software development company, may be a computer hardware manufacturer, may be a financial institution, may be in the logistics industry, may be a construction company, may be an automotive company, may be a bicycle manufacturer, may be a restaurant chain, etc.

Using examples disclosed herein, accessing cloud infrastructure resources of different ones of the cloud providers 202, 204, 206 is a seamless experience for the endpoint user devices 216, 218, 220 and the example tenants 212, 214 in that the cloud providers 202, 204, 206 appear as a single cloud provider to the endpoint user devices 216, 218, 220 and the example tenants 212, 214 because the example tenants 212, 214 do not need to be configured with specific information or methods to interact with the different cloud providers 202, 204, 206. In examples disclosed herein, the service provider 210 enables the example tenants 212, 214 to access cloud infrastructure resources across different ones of the cloud providers 202, 204, 206 without the example tenants 212, 214 needing to create or manage separate login credentials to access the multiple cloud providers 202, 204, 206 and/or without the example tenants 212, 214 needing to be configured with different information or methods (e.g., API calls) to access the multiple cloud providers 202, 204, 206. For example, from the perspective of the service provider 210, the example tenants 212, 214 access the cloud infrastructure resources of the multiple cloud providers 202, 204, 206 through a cloud provider interface account (e.g., an account created in VMware's Cloud Assembly service, which may be implemented by the example cloud-agnostic interface adapter 228) of the service provider 210 using corresponding cloud provider account login credentials stored in the cloud credential database 230. For example, the cloud infrastructure resources are enumerated and the service provider 210 shares the cloud infrastructure resources (e.g., software-defined-data-center (SDDC) infrastructure resources) for access by the example tenants 212, 214 with guardrails and agnostic constructs determined by the example service provider 210. The example tenants 212, 214 are able to use the cloud infrastructure resources, according to the guardrails set by the example service provider 210 without modifying the underlying cloud infrastructure resources to suit the needs of the example tenants 212, 214. As used herein, “guardrails” are resource-to-tenant definitions that specify which resources from which cloud providers 202, 204, 206 are accessible by different tenants 212, 214. For example, the service provider 210 generates guardrails by selecting (e.g., assigning) different ones of the cloud providers 202, 204, 206 from which resources will be provisioned for different ones of the example tenants 212, 214. For example, if the tenants 212, 214 desire access to a fourth cloud provider not selected by the example service provider 210, the guardrails set by the example service provider 210 restrict the example tenants 212, 214 from using resources from the fourth cloud provider. In another example restriction that may be imposed by guardrails, if the service provider 210 exposes a first instance type of one gigabyte of random access memory (RAM) and two central processing units (CPUs) to the example tenants 212, 214, the example tenants 212, 214 are unable to modify the exposed first instance type to a second instance type of two gigabytes of RAM and four CPUs.

As used herein, “agnostic constructs” refer to configuration information such as resource enumerations that make accesses to cloud resources by the tenants 212, 214 agnostic of exactly which cloud provider 202, 204, 206 is providing those cloud resources. For example, if a first tenant 212 requests provisioning of cloud infrastructure resources as a virtual machine, the first tenant 212 is not aware of which specific cloud provider 202, 204, 206 provides the cloud infrastructure resources of the provisioned virtual machine. While the example first cloud provider 202 is a different entity than the example second cloud provider 204 and may operate differently than the example second cloud provider 204, the first cloud provider 202 and the second cloud provider 204 both provide cloud infrastructure resources to provision virtual machines. Using examples disclosed herein, the tenants 212, 214 need not establish and manage separate cloud accounts with the different cloud providers 202, 204, 206 and need not be configured with specific information or methods (e.g., API calls) of accessing the cloud infrastructure resources in accordance with the specific methods of the different cloud providers 202, 204, 206.

In the example of FIG. 2, the service provider 210 allows the example first tenant 212 to access the first cloud provider 202 by providing the first tenant 212 with access to cloud provider account login credentials created by the example service provider 210 for accessing the first cloud provider 202. To manage access to the cloud provider account login credentials, the example cloud credential database 230 of FIG. 2 includes two example rows as follows:

The first row is {id: 1, orgId: 2, data: {“providerOrgId”: “1”, “project”: “3”, “user”: finance@enterprise.com, “password”: “Passw0rd123”}}.

The second row is {id: 2, orgId: 1, data: {“accessKeyId”: “ServiceProviderAccount@firstcloudprovider.com”, “secretAccessKey”: “ServiceKey456”}}.

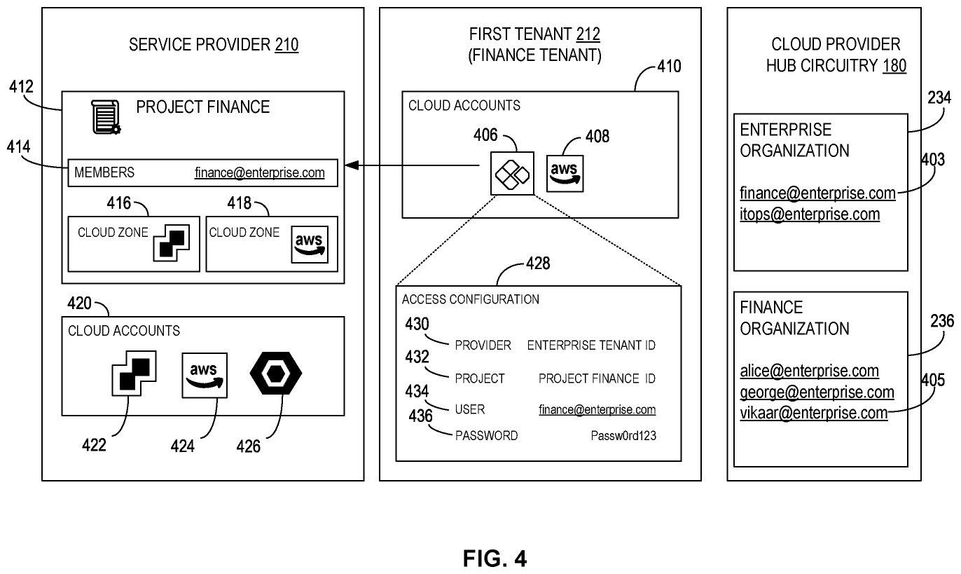

The example first row above contains a project identification (e.g., “3”) which is a project (e.g., location) that the example tenant 212 (e.g., the finance tenant) can access cloud infrastructure resources. The example project is further described below in connection with FIG. 4.

The example first row above contains a username (e.g., finance@enterprise.com) and a password (e.g., “Passw0rd123”) for enterprise login credentials of the first tenant 212 (e.g., a finance tenant).

The example second row above contains an access key identifier (e.g., “ServiceProviderAccount@firstcloudprovider.com”) and a secret access key (e.g., “ServiceKey456”) for cloud provider account login credentials of the example service provider 210 for accessing the first cloud provider 202. In some examples, the cloud provider account login credentials of the example service provider 210 are referred to as service-provider-credentials.

To obtain the cloud provider account login credentials of the second row above, the first tenant 212 submits its enterprise login credentials of the first row above to the cloud-agnostic interface adapter 228. In response, the example cloud-agnostic interface adapter 228 verifies the received enterprise login credentials against the first row above in the cloud credential database 230 and provides the first tenant 212 with access to the cloud provider account login credentials of the second row above. In this manner, the first tenant 212 can use the cloud provider account login credentials to impersonate the example service provider 210 to access cloud resources of the first cloud provider 202 via the cloud-agnostic interface adapter 228. In examples disclosed herein, the username and password (e.g., the enterprise login credentials) collectively define first authorization state data that the example tenants 212, 214 may use to access second authorization state data. In examples disclosed herein, the access key identifier and the secret access key collectively define second authorization state data that the example tenants 212, 214 may use to impersonate the example service provider 210 to example cloud providers 202, 204, 206. In some examples, the first authorization state data is called service-provider-credentials. In some examples, the second authorization state data is called an access token.

An example of accessing cloud resources of the first cloud provider 202 includes the first endpoint user device 216 in the first tenant 212 using the example vRealize Automation® cloud management platform API 144 to request a virtual machine (e.g., a workload) to be provisioned with two gigabytes of memory (e.g., random access memory (RAM)) and a Windows 10 operating system. The example provisioning circuitry 160 determines the cloud zone (e.g., as represented by the cloud providers 202, 204, 206) in which the virtual machine is to be provisioned based on setup configuration criteria. As used herein, the setup configuration criteria includes a placement policy and a capability tag. For example, a placement policy specifies cloud providers from which different resources can be provisioned. Example placement policies may be based on geographic restrictions (e.g., shortest distance from tenant, national restrictions due to data sensitivity, etc.), cloud providers with least monetary costs for certain resources, cloud providers with better performance for some resources, etc. Capability tags may be used to identify resource capabilities of different cloud providers. For example, a cloud provider may have a capability tag indicative of that cloud provider having graphic processor units (GPUs) that satisfy a particular performance threshold, while other cloud providers do not have such a capability tag. In some examples, setup configuration criteria include that the example cloud zones per project might have different cloud administration properties as defined by the example service provider 210 (e.g., a cloud administrator of the example service provider 210). In some examples, the individual cloud zones have a total limit (e.g., a total, a maximum number) on allowed number of virtual machines, memory, storage and CPU which is not modifiable by the example tenants 212, 214. In some examples, the individual projects (irrespective of the number of cloud zones included in the example project) has a placement policy defined (e.g., place virtual machines in the first applicable zone or place virtual machines based on a smallest ratio of number of virtual machines to the number of hosts, etc.).

When deploying a blueprint to a specific project, the actual blueprint definition is used by the example provisioning circuitry 160 to determine which cloud zone should be used in provisioning. For example, in a blueprint, an admin has hardcoded that instance type should be “small” and “small” is defined only in the example region 508 of the example first cloud zone 416 (e.g., a small instance type is only defined in the European-West region that corresponds to the first cloud zone 416).

In some examples, the provisioning circuitry 160 may use a first placement policy that distributes cloud infrastructure resources across clusters based on availabilities of the clusters. For example, the provisioning circuitry 160 may use a second placement policy that places (e.g., provisions) the cloud infrastructure resources on the most loaded host (e.g., server host) that has enough available resources to run the virtual machine (e.g., before provisioning resources on another host). For example, the provisioning circuitry 160 may use a capability tag to provision cloud infrastructure resources to a pre-selected cloud zone. In some examples, the provisioning circuitry 160 determines that the virtual machine is to be provisioned on the first cloud zone, while in the example of FIG. 2, the provisioning circuitry 160 determines that the virtual machine is to be provisioned on the cloud provider interface cloud zone (e.g., Cloud Assembly cloud zone) based on the example provisioning circuitry 160 following the first placement policy.

Because the example provisioning circuitry 160 determined to provision the virtual machine on the cloud interface cloud zone, the example provisioning circuitry 160 calls the cloud-agnostic interface adapter 228 and delivers details regarding the virtual machine (e.g., a workload) such as the memory capacity and the operating system to the example cloud-agnostic interface adapter 228. The example cloud-agnostic interface adapter 228 retrieves a corresponding first authorization state data (e.g., the enterprise login credentials, the username and password), which the cloud-agnostic interface adapter 228 obtained from the request payload from the example provisioning circuitry 160. In examples disclosed herein, the first authorization state is defined collectively by the example enterprise login credentials listed in the example first row of the above cloud credential database 230. The example cloud-agnostic interface adapter 228 requests a cloud provider interface access token (e.g., first authorization state data, service-provider-credentials) from the example cloud provider hub circuitry 180. As used herein, the cloud provider interface access token is the username and password in the first row of the cloud credential database 230 (e.g., finance@enterprise.com; Passw0rd123).

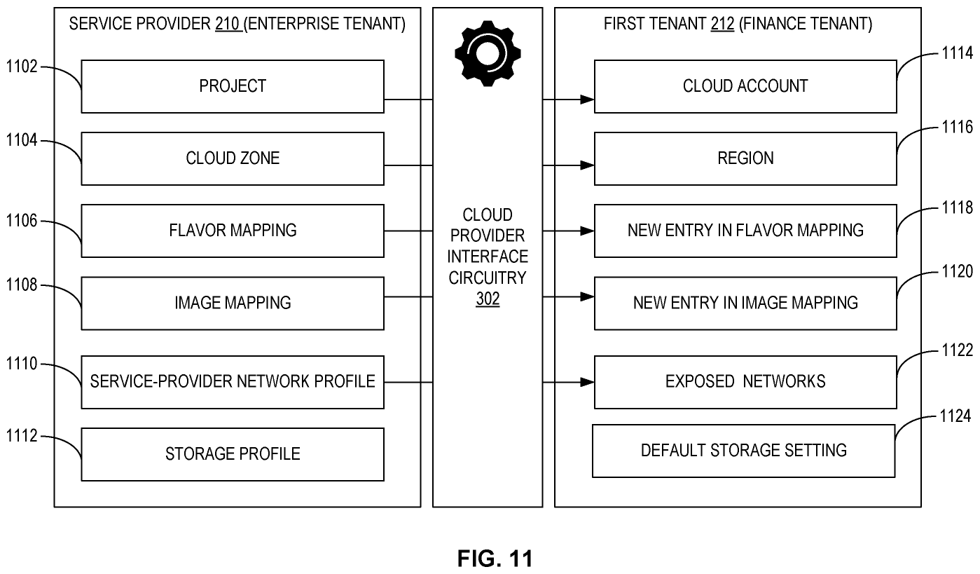

The example cloud-agnostic interface adapter 228 uses the cloud provider interface access token (e.g., first authorization state data) to call the example vRealize Automation® cloud management platform API 144 for a provisioning request. Using the cloud provider interface access token, the first tenant 212 is able to impersonate the example service provider 210 as the entity accessing the first cloud provider 202. That is, when the example vRealize Automation® cloud management platform API 144 receives the cloud provider interface access token from the cloud-agnostic interface adapter 228, the example vRealize Automation® cloud management platform API 144 determines (e.g., believes) that the provisioning call originated from the example service provider 210. The example cloud-agnostic interface adapter 228 has, using an enumeration process described below in connection with FIG. 11, matched service provider constructs to tenant constructs with data mapping. For example, while the example vRealize Automation® cloud management platform API 144 determines (e.g., believes) that the provisioning call originated from the example service provider 210, because of the data mapping, the cloud infrastructure resources will be provisioned to the example project that the example first tenant 212 can access. For example, the “project” in the first row of the cloud credential database 230 is associated with identifier “3” which informs the example vRealize Automation® cloud management platform API 144 to provision the cloud infrastructure resources to the example project.

To determine the cloud zone (e.g., one of the cloud providers 202, 204, 206) in which the virtual machine is to be provisioned, the example provisioning circuitry 160 checks for which cloud zone is identified in a project of the first tenant 212. For example, each tenant 212, 214 is associated with one or more projects, and each project is assigned one or more cloud zones (e.g., each cloud zone is implemented by one of the cloud providers 202, 204, 206). By identifying cloud zones in projects, the cloud providers 202, 204, 206 are exposed to the first tenant 212 by the example service provider 210. As described in more detail below in connection with FIG. 11, an enumeration process is used to assign projects and cloud zones of those projects to the tenants 212, 214. In this manner, guardrails for limiting access to particular cloud zones (e.g., the cloud providers 202, 204, 206) can be implemented using enumerated projects and cloud zones. For example, a particular project for a tenant 212, 214 can be bound to accessing cloud resources from a particular one or more of the cloud providers 202, 204, 206 (e.g., cloud zones) enumerated as part of that project. Such an example project-based guardrail is shown in the first row above of the cloud credential database 230 in which the “project” field is set to “3”, meaning that the tenant account for the first tenant 212 is bound to accessing cloud resources in cloud zones associated with project 3. In the example of FIG. 2, the first cloud provider 202 (e.g., a first cloud zone) is exposed to the first tenant 212 because the example service provider 210 generated a project, assigned the first cloud zone corresponding to the first cloud provider 202 to the project, and associated (e.g., enumerated) the project with the first tenant 212.

After the example provisioning circuitry 160 determines the first cloud zone (e.g., the first cloud provider 202) is where the requested virtual machine (e.g., the workload) is to be provisioned, the example provisioning circuitry 160 uses (e.g., calls) the first cloud-specific adapter 222 to access the first cloud provider 202. To request this access, the example first cloud-specific adapter 222 retrieves corresponding example second authorization state data (e.g., the access key identifier and the secret access key) from the second row of the cloud credential database 230 described above (e.g., “accessKeyId”: “ServiceProviderAccount@firstcloudprovider.com”, “secretAccessKey”: “ServiceKey456”), and uses the second authorization state data to provision the virtual machine (e.g., the workload) in the first cloud zone corresponding to the first cloud provider 202. The second authorization state data allows the example first tenant 212 to impersonate the example service provider 210 when accessing the example first cloud provider 202 so that the example first tenant 212 can access cloud infrastructure resources of the first cloud provider 202 that implement the requested virtual machine (e.g., the workload).

FIG. 3 is a block diagram of the example cloud provider circuitry 170 of FIGS. 1 and 2 structured to allow tenants 212, 214 (FIG. 2) to use cloud infrastructure resources selected by the example service provider 210. The example cloud provider circuitry 170 of FIG. 3 may be instantiated (e.g., creating an instance of, bring into being for any length of time, materialize, implement, etc.) by processor circuitry such as a central processing unit executing instructions. Additionally or alternatively, the example cloud provider circuitry 170 of FIG. 3 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 3 may, thus, be instantiated at the same or different times. Some or all of the circuitry may be instantiated, for example, in one or more threads executing concurrently on hardware and/or in series on hardware. Moreover, in some examples, some or all of the circuitry of FIG. 3 may be implemented by one or more virtual machines and/or containers executing on the microprocessor.

The example cloud provider circuitry 170 accesses cloud infrastructure resources from the example cloud providers 202, 204, 206. The example cloud provider circuitry 170 includes example cloud provider interface circuitry 302, example tenant management circuitry 304, example project generation circuitry 306, example policy management circuitry 308, and example project management circuitry 310. In example FIG. 3, the cloud provider circuitry 170 is in circuit with the example cloud provider hub circuitry 180 which includes the example cloud credential database 230, an example first tenant credential database 234, and an example second tenant credential database 236.

The example cloud provider interface circuitry 302 is in communication with the example cloud providers 202, 204, 206 through the example cloud-specific adapters 222, 224, 226. The example cloud provider interface circuitry 302 is provided to enable the example cloud provider circuitry 170 to integrate with the example cloud providers 202, 204, 206. In some examples, the example cloud provider interface circuitry 302 allows a direct connection to the cloud infrastructure resources of the example cloud providers 202, 204, 206 (e.g., VMware vSphere cloud provider, Microsoft Azure Cloud Services, Amazon Web Services (AWS), Google Cloud Platform, Alibaba Cloud, VMware vCloud Director cloud service delivery platform, etc.). In example FIG. 3, the cloud provider interface circuitry 302 includes a tenant-facing adapter shown as the cloud-agnostic interface adapter 228 that the tenants 212, 214 and the example service provider 210 interact with to access resources in multiple ones of the cloud providers 202, 204, 206. In example FIG. 3, the cloud-agnostic interface adapter 228 is implemented using VMware Cloud Assembly service, which is a cloud template and deployment service provided by VMware, Inc. in the vRealize Automation® cloud management platform 140. In some examples, the Cloud Assembly service is to deploy machines, applications, and services and to provision cloud infrastructure resources. The VMware Cloud Assembly service is only one example of a cloud provider interface. Examples disclosed herein may be implemented using other cloud provider interfaces in addition to or instead of the VMware Cloud Assembly service.

To avoid the need for the example service provider 210 and/or the tenants 212, 214 to be configured with information (e.g., protocols), software, methods (e.g., API calls) specific to each of the cloud providers 202, 204, 206, the example cloud provider interface circuitry 302 connects cloud-specific adapters (e.g., the first cloud-specific adapter 222, the second cloud-specific adapter 224, the third cloud-specific adapter 226) for the cloud providers 202, 204, 206 to a tenant-facing adapter implemented by the example cloud-agnostic interface adapter 228. In this manner, the example cloud provider interface circuitry 302 interprets available cloud infrastructure resources and management constructs defined in the vRealize Automation® cloud management platform 140 for the example cloud providers 202, 204, 206 to enable the example service provider 210 and/or the example tenants 212, 214 to access the resources in the example cloud providers 202, 204, 206 by communicating with the single cloud-agnostic interface adapter 228 using access protocols and methods for the example cloud-agnostic interface adapter 228 while the example cloud provider interface circuitry 302 relays corresponding resource access requests to the example cloud providers 202, 204, 206 via corresponding ones of the example cloud-specific adapters 222, 224, 226.

In some examples, the example cloud provider interface circuitry 302 is used by (e.g., called from) the example first tenant 212 to generate a new layer of cloud infrastructure resource references to refer to the cloud infrastructure resources of the first cloud provider 202. The layer of cloud infrastructure resource references facilitates access to the cloud infrastructure resources by, for example, the example endpoint user devices 216, 218, 220 of the example first tenant 212.

The example tenant management circuitry 304 is in communication with the example first tenant 212 and the example second tenant 214. The example tenant management circuitry 304 is used by the example service provider 210 to allow the example first tenant 212 to access the cloud infrastructure resources based on a tenant account (e.g., corresponding to the first row of the cloud credential database 230 described above) that includes one or more permissions or settings to allow the first tenant 212 to access the selected cloud infrastructure resources. The example first tenant 212 uses the tenant account to access the cloud infrastructure resources, which are selected by the example service provider 210 and are offered by the first cloud provider 202. In other examples, the cloud infrastructure resources accessed by the first tenant 212 are provided by multiples ones of the cloud providers 202, 204, 206. The example tenant management circuitry 304 generates the tenant account based on user credentials that include one or more of an address of the cloud provider account, an organization identification, a project identification, a username and a password, as shown in the first row of the cloud credential database 230 described above. In some examples, the tenant management circuitry 304 generates the tenant account with a resource permission to impersonate the example service provider 210 by using the credentials of the example service provider 210 shown in the second row of the cloud credential database 230 described above.

The example project generation circuitry 306 generates an example project. In some examples, a project includes cloud zone objects and users. As used herein, a project is used by a service provider 210 to organize and govern what users can do (e.g., via the endpoint user devices 216, 218, 220 of FIG. 2) and to which cloud zone objects the users can deploy cloud templates in the cloud infrastructure. The example project generation circuitry 306 generates the example project so that the tenant users (e.g., either the first tenant 212 or endpoint users via the endpoint user devices 216, 218, 220 of the first tenant 212) can access the cloud infrastructure resources.

The example policy management circuitry 308 is to allow the tenant user (e.g., either the first tenant 212 or endpoint users via the endpoint user devices 216, 218, 220 of the first tenant 212) to use the cloud infrastructure resources without modifying the guardrails or agnostic constructs set by the example service provider 210. In some examples, the policy management circuitry 308 allows the tenant user to modify the agnostic constructs. For example, the policy management circuitry 308 determines whether access to a project (e.g., the project 412 of FIG. 4) and its cloud infrastructure resources can be granted to the example tenant 212. In some examples, the policy management circuitry 308 includes a restriction setting in the policy to prevent the tenant from modifying constraints of the cloud infrastructure resources.

The example project management circuitry 310 is to manage the project. The example project management circuitry 310 can assign users (e.g., tenants, members, endpoint users) to projects created by the project generation circuitry 306. In some examples, the example project management circuitry 310 resource-tags (e.g., tags, labels, designates) the cloud infrastructure resources, which allows for easier record keeping and billing and accounting. For example, if the first tenant 212 provisions more resources than the example second tenant 214, the resource-tagging of the example project management circuitry 310 facilitates tracking that the first tenant 212 contributes to more cloud infrastructure resources usage than the second tenant 214. In some examples, the resource-tagging is used to bill the example first tenant 212 more than the example second tenant 214, in response to the example first tenant 212 using more resources. In some examples, the project management circuitry 310 stores a resource tag in a record in association with the cloud infrastructure resource.

The example cloud provider hub circuitry 180 is to generate access tokens based on user credentials (e.g., a username, a password, a organization identifier, etc.). The example cloud provider hub circuitry 180 generates valid access tokens for a specific period of time which may be used by the example first tenant 212 and/or the example second tenant 214 to impersonate the example service provider 210 when accessing cloud resources of the cloud providers 202, 204, 206. In some examples, the cloud provider hub circuitry 180 stores user credentials in the example first tenant credential database 234 (e.g., service provider database) and the example second tenant credential database 236 (e.g., tenant database). The example service provider 210 uses the example cloud provider hub circuitry 180 to store tenant account records in the example first tenant credential database 234. The example first tenant credential database 234 is accessible by the example service provider 210. The example service provider 210 may determine that the first tenant 212 and the second tenant 214 are to access the cloud infrastructure resources based on permissions or settings in corresponding tenant account records. The example first tenant 212 uses the example cloud provider hub circuitry 180 to store endpoint user accounts in the example second tenant credential database 236, where the example second tenant credential database 236 is accessible by the example first tenant 212. Endpoint users corresponding to the first endpoint user device 216 (FIG. 2), the second endpoint user device 218 (FIG. 2), and the third endpoint user device 220 (FIG. 2) have endpoint user accounts stored in the example tenant database 236. An example endpoint user account 405 of the third endpoint user 220 is shown in FIG. 4. An example difference between endpoint user accounts and tenant account is that the endpoint user accounts are for endpoint users to log into an enterprise account of their company (e.g., the first company 208 of FIG. 2) to perform tasks related to their job. An example tenant account 403 shown in FIG. 4 is an account used by the first tenant 212 to confirm its identity to the service provider 210 so that the first tenant 212 can gain access to cloud provider account login credentials of the service provider 210 to access the cloud infrastructure resources selected by the service provider 210 from the cloud providers 202, 204, 206. The example first tenant 212 may be an organization or an internal team inside the first company 208. The endpoint user accounts correspond to real users such as Alice, George, and Vikaar as illustrated in FIG. 4.

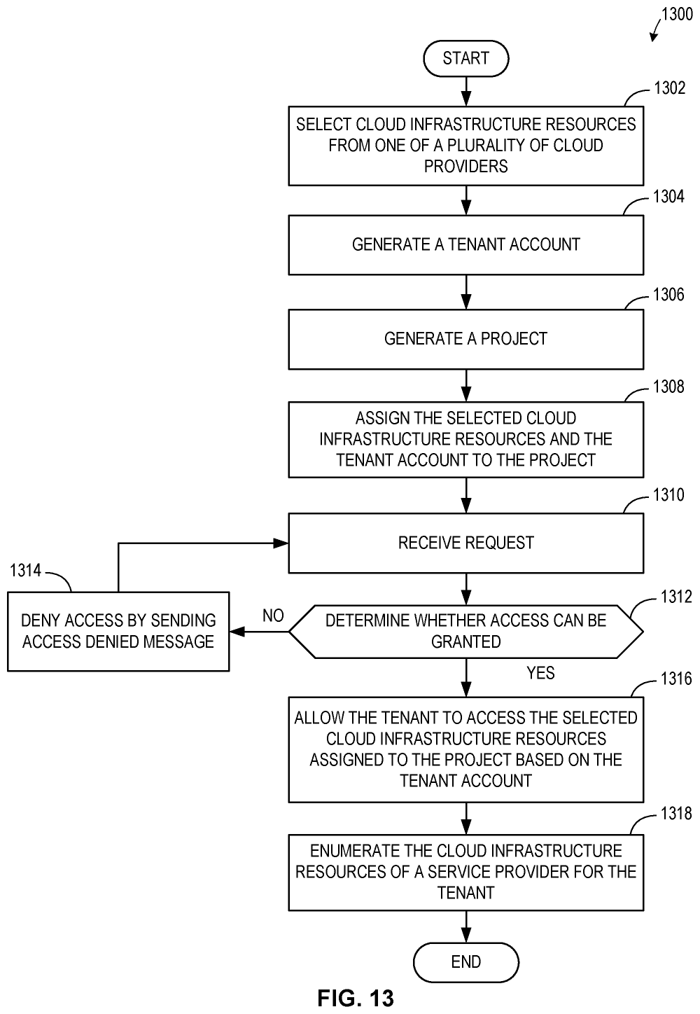

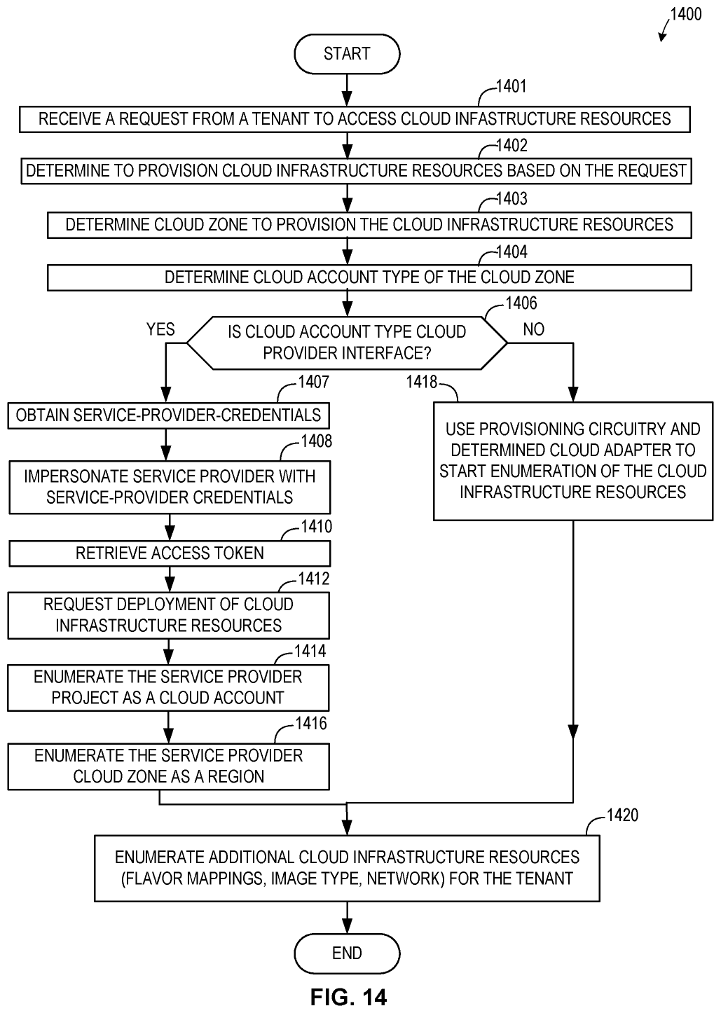

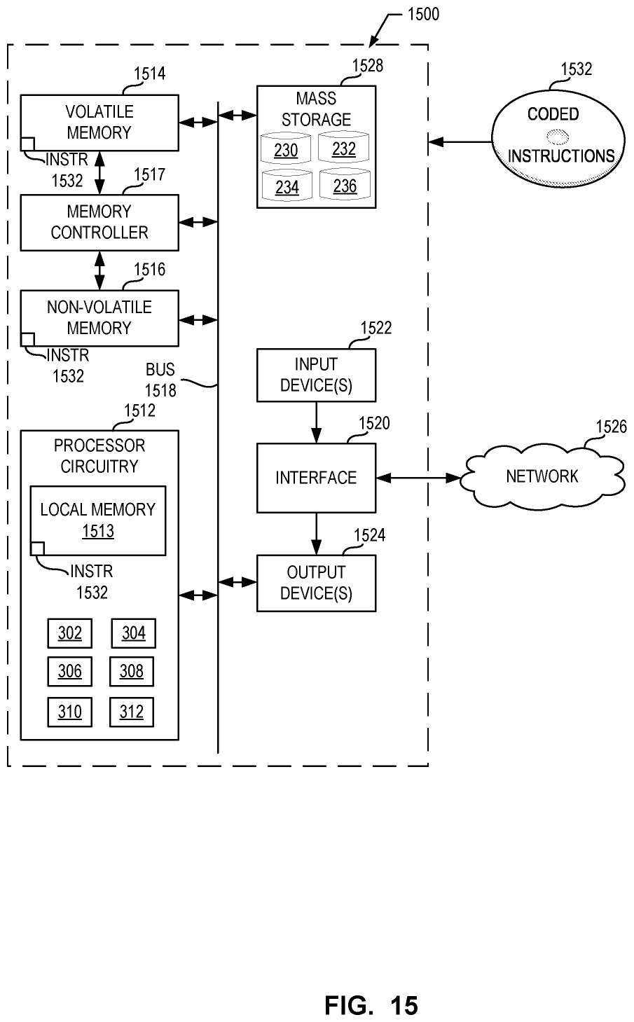

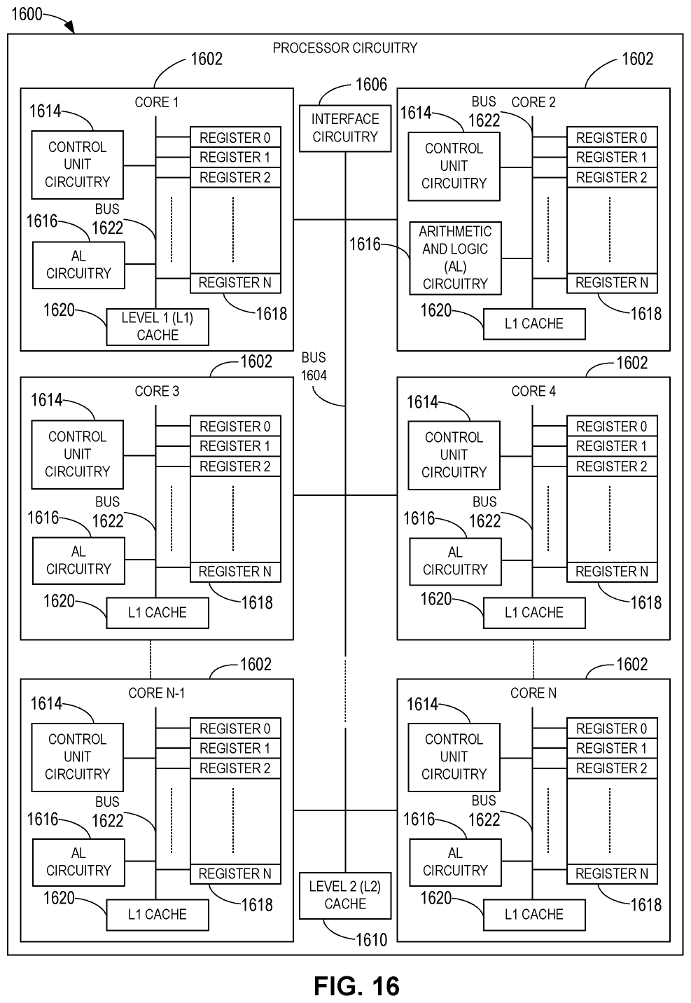

In some examples, apparatus disclosed herein include(s) means for selecting cloud infrastructure resources. For example, the means for selecting cloud infrastructure resources may be implemented by the cloud provider interface circuitry 302. In some examples, the cloud provider interface circuitry 302 may be instantiated by processor circuitry such as the example processor circuitry 1512 of FIG. 15. For instance, the cloud provider interface circuitry 302 may be instantiated by the example general purpose processor circuitry 1500 of FIG. 15 executing machine executable instructions such as that implemented by at least blocks 1302, 1308 of FIG. 13 and at least blocks 1408, 1410, 1412 of FIG. 14. In some examples, the cloud provider interface circuitry 302 may be instantiated by hardware logic circuitry, which may be implemented by an ASIC or the FPGA circuitry 1600 of FIG. 16 structured to perform operations corresponding to the machine readable instructions. Additionally or alternatively, the cloud provider interface circuitry 302 may be instantiated by any other combination of hardware, software, and/or firmware. For example, the cloud provider interface circuitry 302 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, apparatus disclosed herein include(s) means for generating a tenant account. For example, the means for generating a tenant account may be implemented by tenant management circuitry 304. In some examples, the tenant management circuitry 304 may be instantiated by processor circuitry such as the example processor circuitry 1512 of FIG. 15. For instance, the tenant management circuitry 304 may be instantiated by the example general purpose processor circuitry 1500 of FIG. 15 executing machine executable instructions such as that implemented by at least blocks 1304 of FIG. 13. In some examples, the tenant management circuitry 304 may be instantiated by hardware logic circuitry, which may be implemented by an ASIC or the FPGA circuitry 1600 of FIG. 16 structured to perform operations corresponding to the machine readable instructions. Additionally or alternatively, the tenant management circuitry 304 may be instantiated by any other combination of hardware, software, and/or firmware. For example, the tenant management circuitry 304 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, apparatus disclosed herein include(s) means for generating a project. For example, the means for generating a project may be implemented by project generation circuitry 306. In some examples, the project generation circuitry 306 may be instantiated by processor circuitry such as the example processor circuitry 1512 of FIG. 15. For instance, the project generation circuitry 306 may be instantiated by the example general purpose processor circuitry 1500 of FIG. 15 executing machine executable instructions such as that implemented by at least blocks 1306 of FIG. 13. In some examples, the project generation circuitry 306 may be instantiated by hardware logic circuitry, which may be implemented by an ASIC or the FPGA circuitry 1600 of FIG. 16 structured to perform operations corresponding to the machine readable instructions. Additionally or alternatively, the project generation circuitry 306 may be instantiated by any other combination of hardware, software, and/or firmware. For example, the project generation circuitry 306 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the cloud provider circuitry 170 of FIGS. 1 and 2 is illustrated in FIG. 3, one or more of the elements, processes, and/or devices illustrated in FIG. 3 may be combined, divided, re-arranged, omitted, eliminated, and/or implemented in any other way. Further, the example cloud provider interface circuitry 302, the example tenant management circuitry 304, the example project generation circuitry 306, the example policy management circuitry 308, the example project management circuitry 310, the example cloud provider hub circuitry 180, and/or, more generally, the example cloud provider circuitry 170 of FIG. 3, may be implemented by hardware alone or by hardware in combination with software and/or firmware. Thus, for example, any of the cloud provider interface circuitry 302, the example tenant management circuitry 304, the example project generation circuitry 306, the example policy management circuitry 308, the example project management circuitry 310, the example cloud provider hub circuitry 180, and/or, more generally, the example cloud provider circuitry 170, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example cloud provider circuitry 170 of FIGS. 1, 2 may include one or more elements, processes, and/or devices in addition to, or instead of, those illustrated in FIG. 3, and/or may include more than one of any or all of the illustrated elements, processes and devices.

FIG. 4 illustrates how the example first tenant 212 interacts with the example service provider 210 using the example cloud provider hub circuitry 180. The example cloud provider hub circuitry 180 includes the example first tenant credential database 234 and the example second tenant credential database 236. The example first tenant credential database 234 includes a tenant account 403 (e.g., finance@enterprise.com) which is used by the example first tenant 212 to access the example project 412 (e.g., finance project). The example tenant database 236 includes an endpoint user account 405 (e.g., vikaar@enterprise.com). In the example of FIG. 4, a user named Vikaar is an endpoint user logged in via the third endpoint user device 220 of FIG. 2. In some examples, the endpoint user Vikaar may use the example endpoint user device 220 to submit a request for a virtual machine (e.g., for performing financial operations or for any other purpose). In response to the request for the virtual machine from the example third endpoint user device 220, the example provisioning circuitry 160 (FIG. 1) provisions cloud infrastructure resources to provision the virtual machine requested by the example third endpoint user device 220.

The example first tenant 212 (e.g., the finance tenant) has access to cloud accounts 410 which include a first tenant cloud account 406 and a second tenant cloud account 408. The first tenant cloud account 406 is a cloud provider interface account which can be used by the example first tenant 212 to access the example project 412 and through accessing the project 412, the cloud provider interface account is to access multiple cloud providers 202, 204 of FIG. 2. The first tenant cloud account 406 (e.g., a cloud provider interface account) allows efficient access to multiple cloud providers 202, 204, while the second tenant cloud account 408 is a cloud provider account which is configured to access only one cloud provider 202 (e.g., an Amazon Web Services cloud provider which may implement one of the cloud providers 202, 204, 206 of FIG. 2). Using examples disclosed herein, instead of the example first tenant 212 needing multiple tenant cloud accounts 410 to access the multiple cloud providers 202, 204, 206 (e.g., the first tenant 212 would need a first cloud-specific adapter 222 of FIG. 2, a second cloud-specific adapter 224 of FIG. 2, and a third cloud-specific adapter 226 of FIG. 2 in order to access the cloud providers 202, 204, 206 of FIG. 2), the first tenant 212 can use the first tenant cloud account 406 (e.g., the cloud provider interface account) to access the multiple cloud providers 202, 204, 206 of FIG. 2.

The example first tenant 212 (e.g., finance tenant) uses the first tenant cloud account 406 (e.g., the cloud provider interface account) as a way to access the cloud infrastructure resources selected by the example service provider 210. The example service provider 210 places the selected cloud infrastructure resources in the example project 412 as the first cloud zone 416 (e.g., corresponding to the first cloud provider 202) and the second cloud zone 418 (e.g., corresponding to the second cloud provider 204). The example project 412 includes a members list 414 that includes usernames of accounts that can access the project 412.

The example service provider 210 generates the example project 412 (e.g., project finance) using the example project generation circuitry 306 of FIG. 3. The example project 412 includes a members list 414, a first cloud zone 416, and a second cloud zone 418. In the example of FIG. 4, the tenant account 403 (e.g., finance@enterprise.com) is the only authorized member on the example members list 414. The example first tenant 212 (e.g., finance tenant) has access to the example tenant account 403 based on the example access configuration data 428 which includes an organization identification 430 (e.g., Provider: Enterprise Tenant ID), a project identification 432 (e.g., Project: Project Finance ID), and user credentials (e.g., a username 434 and a password 436 for the finance@enterprise.com account, the first authorization state data, etc.).

The example project 412 includes a first cloud zone 416 (e.g., corresponding to the first cloud provider 202 which may be implemented by a vSphere cloud provider) and a second cloud zone 418 (e.g., corresponding to the second cloud provider 204 which may be implemented by an AWS cloud provider). In some examples, the access configuration data 428 is a resource permission to allow the example first tenant 212 (e.g., finance tenant) to access cloud infrastructure resources.

The example service provider 210 is registered for the example vRealize Automation® cloud management platform 140 and has an active organization (e.g., a tenant) assigned. The example service provider 210 uses the example cloud provider hub circuitry 180 to onboard the example first tenant 212 (e.g., finance tenant) as a new tenant in the cloud management platform (e.g., the vRealize Automation® cloud management platform 140 of FIG. 1). The example service provider 210 provides access to a Cloud Assembly service (e.g., a cloud provider interface service) offered by the example vRealize Automation® cloud management platform 140. The example service provider 210 adds at least one cloud account to the example vRealize Automation® cloud management platform and defines at least one zone for the shared infrastructure based on the at least one added cloud account. As used herein, the shared infrastructure refers to the example project 412 which is shared by the example service provider 210 to be accessible by the example first tenant 212.

In the example of FIG. 4, the example service provider 210 selects three cloud accounts in the cloud accounts tab 420 and determines to provision two of the cloud accounts to the example project 412 as available cloud zones to be accessed by the example first tenant 212. In the example of FIG. 4, the example first cloud account 422 is a vSphere account which the example service provider 210 has selected to provision to the example first tenant 212 as the first cloud zone 416 (e.g., a vSphere cloud zone). Also in the example of FIG. 4, the example second cloud account 424 is an Amazon Web Services account which the example service provider 210 has selected to provision to the example first tenant 212 as the second cloud zone 418 (e.g., an Amazon Web Services cloud zone). In the example of FIG. 4, the example service provider 210 did not assign the third cloud account 426 (e.g., a Google Cloud Platform account) to the example project 412. As such, the third cloud account 426 does not define a third cloud zone for the example project 412. In some examples, the service provider 210 sets the example first tenant 212 as a dedicated tenant user within the example service provider 210. In those examples, the dedicated tenant user is the owner of all the data structures generated for the example first tenant 212 in the organization of the example service provider 210.

The example cloud zones 416, 418 are assigned to the example project 412 by the project generation circuitry 306 of the example cloud provider circuitry 170 shown in FIG. 3. The assigned example cloud zones 416, 418 are shared with the example first tenant 212. The assigned example cloud zones 416, 418 are shared with endpoint users that login via the example endpoint user devices 216, 218, 220 of FIG. 2 as represented by the endpoint user accounts in the example second tenant credential database 236. For example, an endpoint user using the third endpoint user device 220 of FIG. 2 may be a user named Vikaar who utilizes an endpoint user account 405 in the example second tenant credential database 236 to access the shared cloud zones 416, 418. In some examples, the example project management circuitry 310 configures a custom name or implements resource-tagging to facilitate resource management (tracking) and billing.

The example service provider 210 provides access configuration data 428 to the example first tenant 212 to access the generated example project 412. The example access configuration data 428 includes an organization identification 430 (e.g., Provider: Enterprise Tenant ID), a project identification 432 (e.g., Project: Project Finance ID), and user credentials (e.g., a username 434 and password 436 for the finance@enterprise.com account). Based on example access configuration data 428, the example first tenant 212 has access to the example project 412. The example first tenant 212 creates a new cloud account of a first cloud zone type (e.g., a Cloud Assembly type, a cloud provider interface type) corresponding to the first cloud zone 416 based on the provided access configuration data 428 (e.g., the organization identification 430, the project identification 432, and the user credentials (e.g., username 434 and password 436)). In some examples, a first cloud administrator (e.g., a person with access to the example first tenant 212) may create the new cloud account of the first cloud zone type for the example first tenant 212. In some examples, a second cloud administrator (e.g., a person with access to the example service provider 210 and the example first tenant 212) may create the new cloud account for the first cloud zone type for the example first tenant 212 by representing itself as being the example first tenant 212. Creating a new cloud account for the first cloud zone type for the example first tenant 212 is a set-up step that may be performed by either the example first tenant 212 or the example service provider 210. The example second cloud administrator with access to both the example service provider 210 and the example first tenant 212 may have an email (e.g., login credentials) stored in the example cloud provider hub circuitry 180 that corresponds to the example service provider 210 and the example first tenant 212.

In response to the generation of the example cloud account of the first cloud zone type, the example cloud provider interface circuitry 302 performs an enumeration process which relates the cloud infrastructure resources of the first cloud zone 416 (e.g., the cloud provider interface, VMware Cloud Assembly) to the cloud infrastructure resources of the example project 412 generated by the example service provider 210. The cloud infrastructure resources (e.g., data structures) for the first cloud zone 416 are based on mappings between the project 412 and the cloud account of the first cloud zone type. FIG. 11 illustrates an enumeration process of how the cloud infrastructure resources of the example service provider 210 are enumerated as cloud infrastructure resources for the example first tenant 212. For example, the example project 412 of the service provider 210 (e.g., the finance project) is enumerated as the first tenant cloud account 406 of the example first tenant 212. More enumerations are described below in conjunction with FIG. 11. After the enumeration process, the example first tenant 212 and the example endpoint user devices of the example first tenant 212 can interact with the shared infrastructure resources provided by the example service provider 210 in the same way as the example endpoint user devices interact with other cloud providers (e.g., the third cloud provider 206 of FIG. 2).

In the example of FIG. 4, the first tenant 212 has access to the first tenant cloud account 406 and the second tenant cloud account 408. The process the first tenant 212 uses to provision cloud infrastructure resources using the second tenant cloud account 408 is different than the process the first tenant 212 uses to provision cloud infrastructure resources using the first tenant cloud account 406 because the first tenant cloud account 406 is a cloud provider interface account and the second tenant cloud account 408 is a cloud provider account.

For provisioning with the second tenant cloud account 408 (e.g., the cloud provider account, the Amazon Web Services account), the example endpoint user device 216 of the first tenant 212 is to receive a token from the example cloud provider hub circuitry 180 in response to providing a username and password, and selecting an organization on an example user interface/screen. The example endpoint user (e.g., person) uses the endpoint user device 216 to log into the cloud provider interface platform and deploy a cloud agnostic virtual machine by specifying a specific project (e.g., the example project 412). As used herein, the endpoint user device 216 is not aware of a specific cloud provider to deploy the virtual machine (thus the virtual machine is a cloud agnostic virtual machine). In the example of FIG. 4, the second tenant cloud account 408 (e.g., the cloud provider account, the Amazon Web Services account) is in direct communication with the example second cloud account 424 (e.g., the Amazon Web Services cloud zone). The example provisioning circuitry determines to provision the virtual machine on the second cloud account 424, based on the second tenant cloud account 408. The example provisioning circuitry 160 uses an example provisioning database 232 and retrieves cloud account related data, and based on the retrieved cloud account related data, the example provisioning circuitry 160 determines the type (e.g., cloud provider type, such as Amazon Web Services, Google Cloud Platform, Microsoft Azure) and the identification data (e.g., credentials document, second authorization state data corresponding to the first cloud provider 202, access configuration data). As used herein, the example cloud account related data includes the type (e.g., cloud provider type) and the identification data (e.g., second authorization state data corresponding to the first cloud provider 202).

Based on the determined cloud provider type, the example provisioning circuitry 160 sends a request to the corresponding adapter. For example, the provisioning circuitry 160 sends a request to the first cloud-specific adapter 222 which is configured to access the example second cloud account 424 (e.g., the Amazon Web services adapter is configured to access the Amazon Web Services cloud provider). The request sent to the corresponding adapter includes the identification data and information relating to the specific cloud infrastructure resources to build the virtual machine. The first cloud-specific adapter 222 retrieves a username (e.g., access key identifier, ServiceProviderKey@firstcloudprovider.com) and a password (e.g., secret access key, AccessKey456) from the identification data. The first cloud-specific adapter 222 (e.g., the Amazon Web Services adapter) uses the username and password to access the first cloud provider 202 (e.g., the Amazon Web Services cloud provider) which corresponds to the example second cloud account 424, and the virtual machine is provisioned (e.g., the cloud infrastructure resources are enumerated). In some examples, where the example first tenant 212 uses the example second tenant account 408 to request resource provisioning, the cloud infrastructure resources provisioned are based on the cloud infrastructure resources available (e.g., offered) by the example cloud provider 202. For example, the second tenant account 408 may refer to an Amazon Web Service account, which does not offer projects 1102 (FIG. 11), cloud zone 1104 (FIG. 11), flavor mappings 1106 (FIG. 11), image mappings 1108 (FIG. 11), network profiles 1110 (FIG. 11), and storage profiles 1112 (FIG. 11).

Instead, the example second tenant account 408 that refers to the Amazon Web Service account, offers regions, availability zones, instance types, machine images, EC2 instances (e.g., virtual machines). Once enumerated, the example endpoint users may create constructs based on the vRealize Automation® cloud management platform 140 constructs in the example project 412 (e.g., a vRealize Automation® cloud management platform 140 flavor mapping for a specific AWS region and AWS instance type, a vRealize Automation® cloud management platform 140 image mapping for specific AWS region and Amazon machine image, and a vRealize Automation® cloud management platform 140 cloud zone for the specific AWS region).

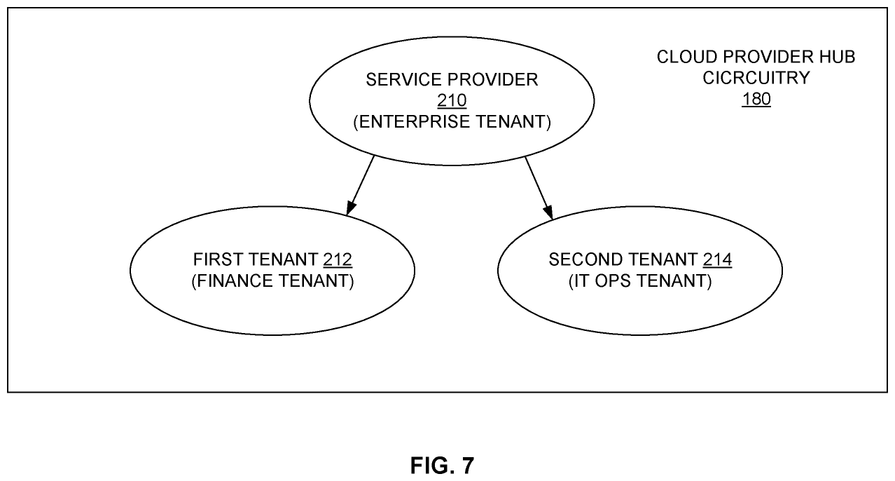

As used herein, an instance type mapping resource refers to a flavor resource. In some examples, some cloud providers (e.g., Amazon Web Services) refer to this cloud infrastructure resource as “flavors,” while other cloud providers (e.g., VMware, Google Cloud Platform, Microsoft Azure, etc.) refer to this cloud infrastructure resource as an “instance type mapping.” As used herein, the flavor (e.g., an instance type mapping) is the number of central processing units (CPU) and amount of random access memory (RAM) that are provisioned to a virtual machine. For example, a medium flavor may include four (“4”) CPUs and eight (“8”) gigabytes of RAM as illustrated in FIG. 7C. An example first virtual private zone may include at least one flavor (e.g., an instance type mapping).

For provisioning with the first tenant cloud account 406 (e.g., the cloud provider interface account, the Cloud Assembly account), the example endpoint user device 216 of the first tenant 212 is to receive a token from the example cloud provider hub circuitry 180 in response to providing a username and password, and selecting an organization on an example user interface/screen. The example endpoint user device 216 logs into the cloud provider interface platform and deploys a cloud agnostic virtual machine by specifying a specific project (e.g., the example project 412). As used herein, the endpoint user device 216 is not aware of a specific cloud provider to deploy the virtual machine (thus the virtual machine is a cloud agnostic virtual machine). In the example of FIG. 4, the first tenant cloud account 406 (e.g., the cloud provider interface account, the Cloud Assembly account) is in communication with the example project 412, and the example project 412 includes exposed cloud zones 416, 418 for provisioning. The first cloud zone 416 is a vSphere cloud zone and the second cloud zone 418 is an Amazon Web Services cloud zone. The example provisioning circuitry 160 determines to provision the virtual machine on the second cloud account 424, based on the exposed cloud zones 416, 418. Based on the determined cloud zone for provisioning (e.g., the second cloud zone 418), the example provisioning circuitry 160 uses an example provisioning database 232 and retrieves cloud account related data, and based on the retrieved cloud account related data, the example provisioning circuitry 160 determines the type which is of type cloud provider interface for the first tenant cloud account 406. The example provisioning circuitry 160 also determines identification data (e.g., credentials document, first authorization state data corresponding to the service provider 210, access configuration data, first token). As used herein, the example cloud account related data includes the type (e.g., cloud provider type) and the identification data (e.g., first authorization state data corresponding to the service provider 210, first token).

Based on the determined cloud provider type, the example provisioning circuitry 160 sends a request to the corresponding adapter. For example, the provisioning circuitry 160 sends a request to the cloud-agnostic interface adapter 228 by providing the identification data and information relating to the specific cloud infrastructure resources to build the virtual machine. The cloud-agnostic interface adapter 228 retrieves the example service-provider organization identification 430 (e.g., service-provider organization identification), the example project identification 432, the example username 434 (e.g., finance@enterprise.com, service-provider username) and the example password 436 (e.g., Passw0rd123) from the example provisioning database 232. The cloud-agnostic interface adapter 228 retrieves a token from the example cloud provider hub circuitry 180 using the organization identification 430, the example username 434 and the example password 436.

The example cloud-agnostic interface adapter 228 uses the token to call the example vRealize Automation® cloud management platform 140 to deploy a cloud agnostic virtual machine. Based on the first authorization state data (e.g., first token), the example vRealize Automation® cloud management platform 140 because of the authorization state data (e.g., first token) believes the example service provider 210 is requesting a deployment of a cloud agnostic virtual machine. That is, the example tenant 212 is impersonating the example service provider 210 with the retrieved token. The example cloud interface platform 140 specifies the project 412 based on the project identification 432 to deploy the cloud agnostic virtual machine, and the example tenant 212 is able to use the cloud agnostic virtual machine deployed to the project 412. The example tenant 212 is able to use any collection of cloud infrastructure resources deployed to the project 412, because the example tenant 212 is a member of the example project 412. Because the original tenant's request for the cloud agnostic virtual machine includes a description of the cloud infrastructure resources required to build the virtual machine, the virtual machine that the first tenant 212 requests will be provisioned in a location that the first tenant 212 can access the virtual machine.

After the cloud-agnostic interface adapter 228 determines the project 412 as the location to provision the virtual machine, the cloud-agnostic interface adapter 228 uses the example provisioning circuitry 160 with similar steps to how the second tenant cloud account 408 was provisioned as described above. The example provisioning circuitry 160 uses an example provisioning database 232 and retrieves cloud account related data, and based on the retrieved cloud account related data, the example provisioning circuitry 160 determines the cloud provider type (e.g., Amazon Web Services, Google Cloud Platform, Microsoft Azure) and the identification data (e.g., credentials document, second authorization state data corresponding to the first cloud provider 202, access configuration data). As used herein, the example cloud account related data includes the type (e.g., cloud provider type) and the identification data (e.g., second authorization state data corresponding to the first cloud provider 202).

Based on the determined cloud provider type, the example provisioning circuitry 160 sends a request to the corresponding adapter (e.g., one of the cloud-specific adapters 222, 224, 226). For example, the provisioning circuitry 160 sends a request to the example first cloud-specific adapter 222 which is configured to access the example second cloud account 424 (e.g., the Amazon Web services adapter is configured to access the Amazon Web Services cloud provider). The request sent to the corresponding adapter includes the identification data and information relating to the specific cloud infrastructure resources to build the virtual machine. The example first cloud-specific adapter 222 retrieves a username (e.g., access key identifier, ServiceProviderKey@firstcloudprovider.com) and a password (e.g., secret access key, AccessKey456) from the identification data. The example first cloud-specific adapter 222 (e.g., the Amazon Web Services adapter) uses the username and password to access the first cloud provider 202 (e.g., the Amazon Web Services cloud provider) which corresponds to the example second cloud account 424, and the virtual machine is provisioned on the example project 412. By using the example first tenant cloud account 406 (e.g., cloud provider interface account), and by impersonating the example service provider 210, the example tenant 212 does not require multiple cloud provider accounts for endpoint users of the endpoint user devices 216, 218, 220 to access provisioned virtual machines or other resources provided by the multiple cloud providers 202, 204, 206.

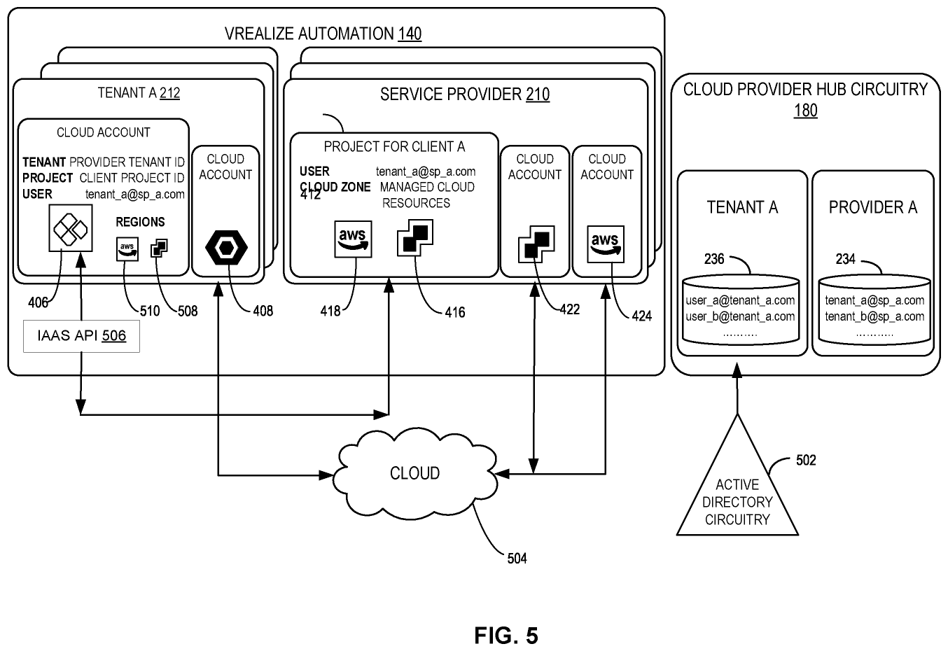

FIG. 5 illustrates an example of how the example first tenant 212 is in communication with the example service provider 210 through the example cloud provider hub circuitry 180. FIG. 5 includes the example cloud provider hub circuitry 180, which includes the example first tenant credential database 234 (e.g., service provider database, PROVIDER A) and an example second tenant credential database 236 (e.g., TENANT A). FIG. 5 includes example active directory circuitry 502 which is to perform confirmations (e.g., verification checks) of the accounts in the example first company 208 (e.g., enterprise). The example cloud provider hub circuitry 180 discovers accounts and displays the accounts so that the example first company 208 can select which accounts are to be added to provide organizations access rights to certain services or resources.

In the example of FIG. 5, the example first tenant credential database 234 includes a first tenant account (e.g., tenant_a@sp_a.com) and a second tenant account (e.g., tenant_b@sp_a.com). In the example of FIG. 5, the example second tenant credential database 236 includes a first endpoint user account (e.g., user_a@tenant_a.com) and a second endpoint user account (e.g., user_b@tenant_a.com).

The example service provider 210 has a first cloud account 422 which accesses cloud infrastructure resources from the example first cloud provider 202 of FIG. 2 (e.g., VMware vSphere cloud provider), and a second cloud account 424 which accesses cloud infrastructure resources from the example second cloud provider 204 of FIG. 2 (e.g., Amazon Web Services cloud provider). The example service provider 210 generates an example project 412, assigns the first cloud account 422 which corresponds to a first cloud zone 416 in the example project 412, and assigns the second cloud account 424 which corresponds to a second cloud zone 418 in the project 412.

As used herein, a region is defined by a datacenter that is placed in a geographic location on the Earth that supports the cloud account. For example, a first region may be the North-American-Data-Center that supports a first cloud provider 202 (e.g., vSphere as developed and sold by VMware, Inc.).

As used herein, cloud accounts have regions. For example, the second cloud account 424 (e.g., an Amazon Web Services cloud account) may have a European-Union-West-1 region, a United-States-East-2 region. The example third cloud account 426 (e.g., a Google Cloud Platform cloud account) may have a Europe-West-1 region and an Asia-East-1 region. The example first cloud account 422 (e.g., a vSphere cloud account) may have a Datacenter-21 region and a Datacenter-30 region.

As used herein, a cloud zone is a construct in vRealize Automation® cloud management platform 140 which maps to a region of one of the example cloud providers 202, 204, 206. The example service provider 210 may have multiple cloud zones defined for the same region, one cloud zone per region, or no cloud zones for some regions. The example provisioning circuitry 160 uses the example cloud zones to determine in which region to provision the cloud infrastructure resources (e.g., virtual machines, workloads).

The example service provider 210 has assigned an example first tenant cloud account (e.g., cloud provider interface account) and an example second tenant cloud account 408 (e.g., cloud provider account) to the example first tenant 212. The example vRealize Automation® cloud management platform 140 includes an example infrastructure-as-a-service (IAAS) API 506. By using an example IAAS API 506 with the example first tenant cloud account 406 (e.g., cloud provider interface account), the example first tenant 212 is able to access the first cloud zone 416 in the example project 412 and the example second cloud zone 418 in the example project 412. Because the example tenant 212 has access to the cloud zones 416, 418 through the example IAAS API 506, the example first tenant 212 has access to an example first region 508 (e.g., a VMware vSphere region) corresponding to the example first cloud zone 416 and to an example second region 510 (e.g., an Amazon Web Service region) corresponding to the example second cloud zone 418.

In the example of FIG. 5, four cloud accounts are illustrated: the example first tenant cloud account 406 (e.g., Cloud Assembly cloud provider interface account), the example second tenant cloud account 408 (e.g., in FIG. 5, the second tenant cloud account 408 is Google Cloud Platform cloud provider account, while in FIG. 4, the second tenant cloud account 408 is an Amazon Web Services cloud provider account), the example first cloud account 422 (e.g., vSphere cloud provider account), and the example second cloud account 424 (e.g., Amazon Web Service cloud provider account). FIG. 5 illustrates an example cloud 504 (which represents the individual cloud providers 202, 204, 206 of FIG. 2) which is in communication with the example second tenant cloud account 408, the example first cloud account 422, and the example second cloud account 424.

Techniques disclosed herein improve operating efficiencies of computing systems relative to prior techniques because, rather than the example service provider 210 providing (i) the example second tenant cloud account 408, (ii) the example first cloud account 422, and (iii) the example second cloud account 424 to the example first tenant 212, the example service provider 210 can provide (i) the example second tenant cloud account 408 and (iv) the example first tenant cloud account 406 (e.g., providing two separate entities (i) the second tenant cloud account 408 and (iv) the example first tenant cloud account 406 instead of providing three separate entities (i) the example second tenant cloud account 408, (ii) the example first cloud account 422, and (iii) the example second cloud account 424 to the example first tenant 212) so that the example first tenant cloud account 406 can grant access to the example first cloud zone 416 in the form of the example first region 508 and grant access to the example second cloud zone 418 in the form of the example second region 510. By granting access to the example first cloud zone 416, techniques disclosed herein allow similar access to the example first cloud account 422, because the example first cloud zone 416 is based on the example first cloud account 422.

Techniques disclosed herein relate to different usage examples between the example service provider 210 and the example first tenant 212. In some examples, the example service provider 210 can onboard (e.g., generate an account with, sign-up for, register for, etc.) a software defined data center (SDDC) as a cloud account in the organization of the example service provider 210. By onboarding the SDDC as a cloud account, the example service provider 210 has access to an example provisioning service as a cloud provider. For example, the SDDC may implement the example provisioning service as a cloud provider by using the example cloud-agnostic interface adapter 228 (FIGS. 2, 3) of the example cloud provider circuitry 170 (FIGS. 1-3). The example cloud provider circuitry 170 (e.g., the provisioning service as a cloud provider) is able to expose example tenants 212, 214 to any other solution for sharing cloud infrastructure resources. For example, the other solutions for sharing cloud infrastructure resources may be implemented by the example cloud-specific adapters 222, 224, 226 of FIG. 2. In these examples, adding such a cloud account would create a tenant-facing cloud-agnostic interface defined by a cloud provider interface service such as the example Cloud Assembly cloud provider interface.

In some examples, the service provider 210 creates cloud zones in the provider organization—to allocate to tenants, and the example cloud provider circuitry 170 (e.g., the provisioning service as a cloud provider) is able to follow the standard workflow to add cloud accounts. For each tenant (e.g., client), a dedicated project is created and available cloud zones are assigned to the dedicated project. In these examples, the project is the structure used by the example service provider 210 to define what is available for the example first tenant 212.

In some examples, the service provider 210 creates flavor (e.g., instance type) mappings, image mappings, network and storage profiles to provide the information needed for the cloud zone to be usable. As used herein, an instance type mapping resource refers to a flavor resource. In some examples, some cloud providers (e.g., Amazon Web Services) refer to this cloud infrastructure resource as “flavors,” while other cloud providers (e.g., VMware, Google Cloud Platform, Microsoft Azure, etc.) refer to this cloud infrastructure resource as an “instance type mapping.” As used herein, the flavor (e.g., an instance type mapping) is the number of central processing units (CPU) and amount of random access memory (RAM) that are provisioned to a virtual machine. For example, a medium flavor may include four (“4”) CPUs and eight (“8”) gigabytes of RAM as illustrated in FIG. 7C. An example first virtual private zone may include at least one flavor (e.g., an instance type mapping).

In such examples, the example cloud provider circuitry 170 (e.g., the provisioning service as a cloud provider) performs an enumeration process which creates these constructs for the example first tenant 212. The example service provider 210 configures the available shared cloud infrastructure resources in the cloud provider interface service account (e.g., Cloud Assembly account) and is to determine which cloud infrastructure resources are to be shared (e.g., available) for the example first tenant 212 to access. Based on the definitions created by the example service provider 210, mapping definitions are created by the example first tenant 212. For example, a project is enumerated as a cloud account, a cloud zone is enumerated as a region, a flavor mapping is enumerated as a new entry in flavor mapping, and an image mapping is enumerated as a new entry in image mapping. In addition, the network profile of the service provider 210 is used to enumerate the specific networks inside the network profile, for the example first tenant 212, but the network profile itself is not enumerated to the example first tenant 212. The storage profile of the example service provider 210 is not enumerated for the example first tenant 212, so the example first tenant 212 accesses a default storage setting in order to provision the virtual machines. As used herein, a default storage setting is a storage policy determined by preferences of the example cloud provider 202. Regions from the example first tenant cloud account 406 of FIG. 5 (e.g., cloud provider interface account) are not enumerated, which removes any potential circular relations.

In some examples, the service provider 210 creates capability tags for cloud zones and other provider constructs that provide the guardrails for the example tenants that use the provider constructs and cloud zones. In such examples, the cloud provider circuitry 170 (e.g., the provisioning service as a cloud provider) is able to follow the standard process provided by a cloud provider interface service (e.g., Cloud Assembly cloud provider interface service) for which a cloud administrator for the example service provider 210 executes the process.

In some examples, the service provider 210 allocates a cloud zone-to-tenant organization in a shared mode or in a dedicated mode, in which VPC-based isolation (e.g., virtual private cloud-based isolation) is created in a SDDC (e.g., Software-Defined Data Center) platform or an NSX (e.g., Network Security Virtualization) platform. In such examples, the cloud provider circuitry 170 (e.g., the provisioning service as a cloud provider) is able to create a new cloud account of type cloud assembly by selecting (e.g., referencing, pointing to) the dedicated project in the service provider 210. The enumeration process is used by the provisioning circuitry 160 (FIGS. 1-2) to find the available regions and the cloud administrator creates the cloud zones as needed. Operations to add a new cloud account are performed by the cloud administrator to configure the image mappings, flavor mappings, network profiles, and storage profiles.

In some examples, the service provider 210 views all the on-boarded cloud accounts and cloud zones with a list of the tenants currently allocated to the zones. In such examples, the cloud provider circuitry 170 (e.g., the provisioning service as a cloud provider) is to use a tagging solution to track the on-boarded cloud accounts, despite that there is not a direct API call (e.g., function, method) to return the tracked data from the example vRealize Automation® cloud management platform 140 (e.g., server) to the service provider 210.

In some examples, the service provider 210 views provider-allocated cloud zones. In such examples, names or identifiers of the provider-allocated cloud zones are the only information that can be seen by the first tenant 212 without cloud account visibility. Also in such examples, the cloud provider circuitry 170 (e.g., the provisioning service as a cloud provider) is able to use a policy to obscure the specifics of the underlying cloud account of the example service provider 210, while allowing the first tenant 212 to view all the allocated cloud zones as regions for the cloud account that the first tenant 212 has created. In these examples, the cloud zones may be from various cloud providers.

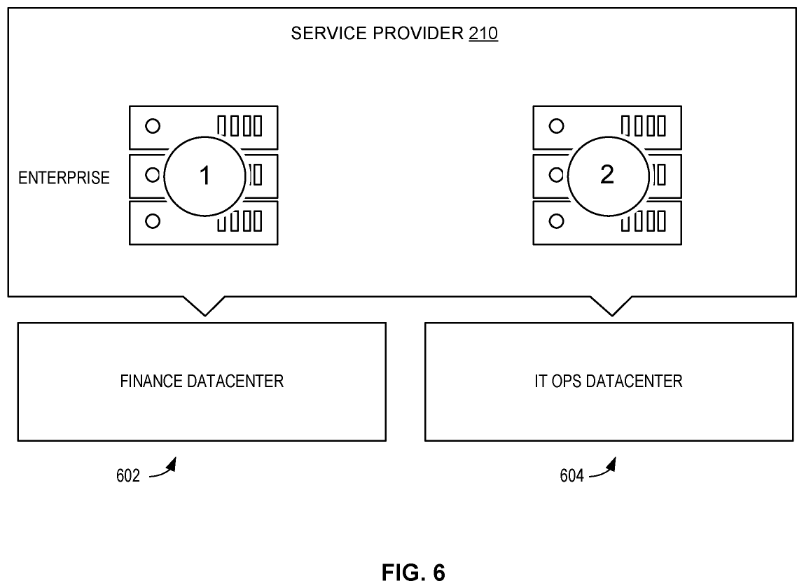

FIG. 6 illustrates the example service provider 210 which has determined to share cloud infrastructure resources with two internal tenants (e.g., internal departments, internal teams, etc.) such as the tenants 212, 214 of FIG. 2. For example, the service provider 210 can allow the first tenant 212 to access a first datacenter 602 (e.g., a Finance datacenter) provisioned using cloud infrastructure resources, and can allow the second tenant 214 to access a second datacenter 604 (e.g., an IT Ops datacenter) provisioned using other cloud infrastructure resources. In some examples, the datacenters 602, 604 are implemented using the VMware vCenter® virtual infrastructure server 130 of FIG. 1.

FIG. 7 illustrates the example service provider 210 onboarding the example first tenant 212 and the example second tenant 214 in the example cloud provider hub circuitry 180. The example service provider 210 generates two new tenants and activates the example vRealize Automation® cloud management platform 140 of FIG. 1 (e.g., a cloud provider interface service, a VMware Cloud Assembly service).

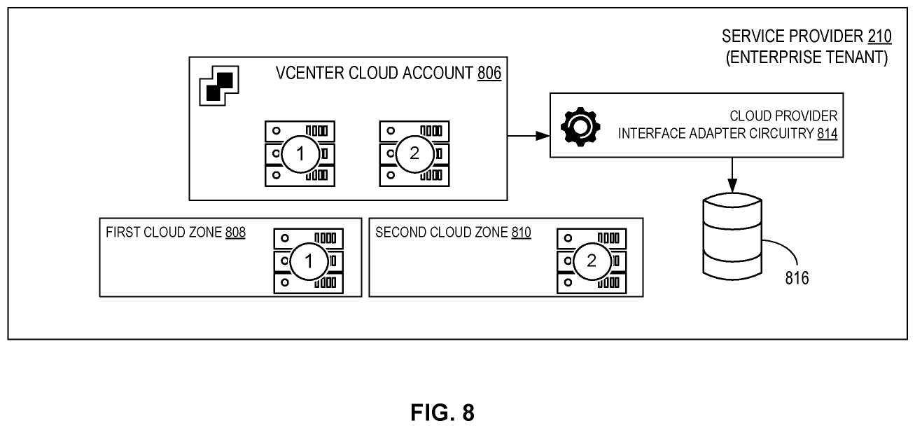

FIG. 8 illustrates the example service provider 210 generating a shared cloud account 806. The example shared cloud account 806 enables the first tenant 212 and the second tenant 214 to share the cloud provider account login credentials of the service provider 210 to impersonate the service provider 210 when accessing different ones of the cloud providers 202, 204, 206. For example, the service provider 210 defines multiple cloud zones corresponding to different ones of the cloud providers 202, 204, 206. An example first cloud zone 808 is for the first tenant 212 (e.g., which accesses the finance datacenter 602 of FIG. 6 provisioned in one of the cloud providers 202, 204, 206 corresponding to the first cloud zone 808) and an example second cloud zone 810 is for the second tenant 214 (e.g., which accesses the IT OPS datacenter 604 of FIG. 6 provisioned in one of the cloud providers 202, 204, 206 corresponding to the second cloud zone 810). The example service provider 210 uses cloud provider interface circuitry 814 (e.g., implemented by the example cloud provider interface circuitry 302 of FIG. 3) to access an example cloud-provider-cloud-infrastructure-resources database 816. The example cloud-provider-cloud-infrastructure-resources database 816 stores records or information of cloud infrastructure resources (e.g., datacenters, hosts, clusters, and networks) from the example cloud providers (e.g., the first cloud provider 202 of FIG. 2). In some examples, the enumeration process of FIG. 11 is to retrieve the cloud infrastructure resources from the cloud providers and to enumerate the cloud infrastructure resources in the cloud-provider-cloud-infrastructure-resources database 816 to be accessible by the example service provider 210.

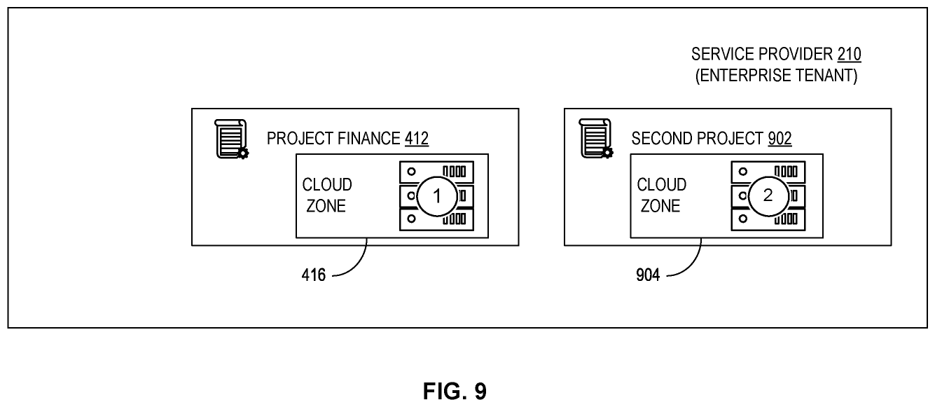

FIG. 9 illustrates the example service provider 210 creating a project for the example tenants 212, 214. The example project 412 is a dedicated project for the first tenant 212 (e.g., finance tenant) that accesses the finance datacenter 602 of FIG. 6. The example project 412 includes a first cloud zone 416. In the example of FIG. 9, the second cloud zone 418 of FIG. 4 is not illustrated. However, the second cloud zone 418 of FIG. 4 may be included in the example project 412. Example FIG. 9 also includes a second project 902 which includes a third cloud zone 904. In some examples, the example project 412 can deploy workloads to specific datacenters (e.g., the finance datacenter 602 of FIG. 6). In such examples, the first cloud zone 416 may be configured to contain only these datacenters. However, in other examples, the first cloud zone 416 may be configured to additionally or alternatively include other datacenters.

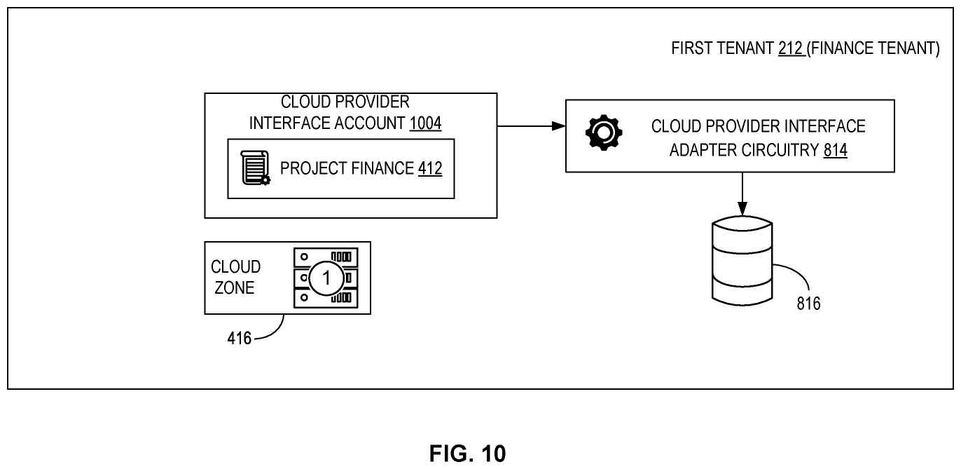

FIG. 10 illustrates the example first tenant 212 structured to generate an example cloud provider interface account 1004. In some examples, a cloud administrator for the example first tenant 212 generates the example cloud provider interface service account 1004. In some examples, the example cloud provider interface service account 1004 is a cloud account of cloud provider interface type (e.g., VMware Cloud Assembly cloud provider interface type). The example cloud provider interface service account 1004 is connected to the cloud provider interface circuitry 814 which is to access the cloud-provider-cloud-infrastructure-resources database 816. To generate a cloud account, the example service provider 210 provides the access configuration data 428 of FIG. 4 to the example first tenant 212. The example access configuration data 428 of FIG. 4 includes the example organization identification 430 of FIG. 4, the example project identification 432 of FIG. 4, and user credentials of FIG. 4. The user credentials of FIG. 4 are the example username 434 and the example password 436.

FIG. 11 illustrates an example enumeration process to enumerate cloud infrastructure resources (e.g., cloud infrastructure constructs) based on the impersonation of the service provider 210 by the first tenant 212. For example, the first cloud provider 202 provisions a virtual machine represented by the cloud infrastructure resources based on a request from the example service provider 210. Because the example first tenant 212 has the cloud provider account login credentials of the example service provider 210, the example first tenant 212 is able to request the provisioning of cloud infrastructure resources. As a result, the cloud-agnostic interface adapter 228 (FIG. 2) maps the data from the service provider 210 as accessible data for the first tenant 212. Thus, the enumeration process converts service-provider-cloud-infrastructure resources as tenant-cloud-infrastructure resources. For example, the cloud infrastructure resources accessed by the example service provider 210 are enumerated by the cloud provider interface circuitry 814 as different cloud infrastructure resources for the example first tenant 212 (e.g., finance tenant). The example service provider 210 has access to an example service-provider-project 1102, an example service-provider-cloud-zone 1104, an example flavor mapping 1106, an example image mapping 1108, an example service-provider network profile 1110, and an example storage profile 1112.

The example first tenant 212 accesses the service-provider-project 1102 based on a cloud account 1114 enumerated by the cloud provider interface circuitry 302. In operation, the example service provider 210 accesses the service-provider-project 1102, while the example first tenant 212 accesses the cloud account 1114. In example FIG. 11, the example cloud provider interface circuitry 302 enumerates the example service-provider-cloud zone 1104 as a region 1116 in the example first tenant 212. The example cloud provider interface circuitry 302 enumerates the example flavor mapping 1106 (e.g., instance type mapping) as a new entry in flavor mapping 1118 for the first tenant 212. The example cloud provider interface circuitry 302 enumerates the example image mapping 1108 as a new entry in image mapping 1120 for the first tenant 212.

The example cloud provider interface circuitry 302 enumerates the example service-provider network profile 1110 as exposed networks 1122 for the first tenant 212. For example, the service-provider network profile 1110 includes explicitly defined user-included networks. During enumeration, the example cloud provider interface circuitry 302 enumerates the networks that define the service-provider network profile 1110 as the exposed networks 1122 to the example first tenant 212, but the actual service-provider network profile 1110 is not enumerated to the example first tenant 212. In this manner, the example service provider 210 can control which specific networks in the example service-provider network profile 1110 are exposed to the example first tenant 212 as the exposed networks 1122.

In the illustrated example of FIG. 11, the example storage profile 1112 of the service provider 210 is not enumerated for the example first tenant 212 because the example first tenant 212 uses a default storage setting 1124 based on preferences of the example cloud provider 202. an example tenant storage profile 1124 instead. In some examples, the exposed networks 1122 and the tenant storage profile 1124 are based on the example region 1116 that includes the networks identified in the network profile 1122 and storage devices identified in the storage profile 1112.

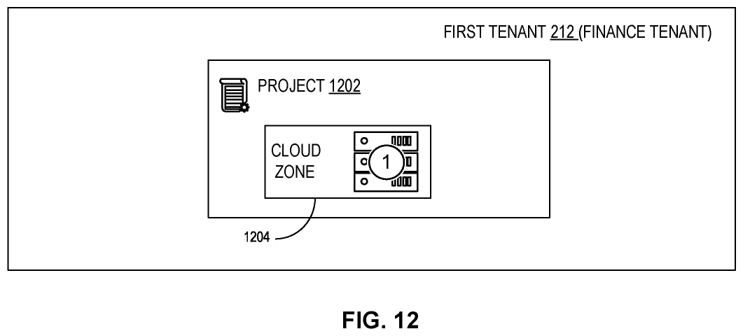

FIG. 12 illustrates how the example endpoint users (represented by the example endpoint user devices 216, 218, 220 of FIG. 2) of the first tenant 212 (e.g., the tenant that accesses the finance datacenter 602 of FIG. 6) are to use the cloud infrastructure resources in the standard (e.g., normal) way. In the example of FIG. 12, an example project 1202 with an example cloud zone 1204 are generated by an example endpoint user (e.g., via the endpoint user device 220 of FIG. 2). For example, the first tenant 212 is able to generate projects (e.g., the example project 1202), assign cloud zones (e.g., the cloud zone 1204) to the projects, and assign project members or endpoint users to the projects. The first tenant 212 can generate its own cloud zones which are based on the regions of the service provider 210 (FIG. 2).

Flowcharts representative of example hardware logic circuitry, machine readable instructions, hardware implemented state machines, and/or any combination thereof for implementing the cloud provider circuitry 170 of FIG. 3 are shown in FIGS. 13-14. The machine readable instructions may be one or more executable programs or portion(s) of an executable program for execution by processor circuitry, such as the processor circuitry 1512 shown in the example processor platform 1500 discussed below in connection with FIG. 15 and/or the example processor circuitry discussed below in connection with FIGS. 16 and/or 17. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 13-14, many other methods of implementing the example cloud provider circuitry 170 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 13 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 13 is a flowchart representative of example machine readable instructions and/or example operations 1300 that may be executed and/or instantiated by processor circuitry to provision cloud infrastructure resources in accordance with teachings of this disclosure. The machine readable instructions and/or the operations 1300 of FIG. 13 begin at block 1302, at which the example cloud provider interface circuitry 302 (FIG. 3) selects cloud infrastructure resources from one of a plurality of cloud providers 202, 204, 206 (FIG. 2). For example, the service provider 210 (FIGS. 2, 4, 5) may use the cloud provider interface circuitry 302 (FIG. 3) to select cloud infrastructure resources from the first cloud provider 202.

At block 1304, the example tenant management circuitry 304 (FIG. 3) generates a tenant account 403 (FIG. 4). For example, the tenant management circuitry 304 may generate a tenant account 403 by storing a username and password in the first tenant credential database 234. The tenant account 403 includes the access configuration data 428 (FIG. 4) to allow the example first tenant 212 to access the project 412 (FIG. 4). The example tenant account 403 is created for the first tenant 212 to provide the first tenant 212 access to the cloud infrastructure resources selected at block 1302.

At block 1306, the example project generation circuitry 306 generates a project (e.g., the project 412). For example, the project generation circuitry 306 may generate the project 412 which includes members on the example members list 414 and cloud zones 416, 418, by assigning (i) at least one of the example tenants 212, 214 as the members on the example members list 414 and (ii) cloud zones corresponding to cloud providers 202, 204, 206 to the project 412. As used herein, the example project 412 is used to provision cloud infrastructure resources (e.g., virtual machines, workloads) and is accessible by endpoint users through the example endpoint user devices 216, 218, 220.

At block 1308, the example project generation circuitry 306 assigns the selected cloud infrastructure resources and the tenant account 403 to the project 412. For example, the project generation circuitry 306 may assign the selected cloud infrastructure resources as a first cloud zone 416 to the project 412 by assigning to the project 412 the first cloud zone 416 that corresponds to the cloud providers 202, 204, 206.

At block 1310, the example cloud provider interface circuitry 302 receives a request from the example first tenant 212 to access the cloud infrastructure resources. For example, the cloud provider interface circuitry 302 may receive a request via a network communication from the first tenant 212 to access or employ one of the cloud infrastructure resources selected at block 1302.

At decision block 1312, the example policy management circuitry 308 determines whether access can be granted. For example, the policy management circuitry 308 determines whether access to the project 412 and the cloud infrastructure resources can be granted to the example first tenant 212 in response to the request received at block 1310. For example, the policy management circuitry 308 may determine to grant the first tenant 212 access to the project 412 based on the example first tenant 212 having the first authorization state data (e.g., service-provider-credentials) corresponding to the example service provider 210. Alternatively, the example policy management circuitry 308 may determine to deny the first tenant 212 access to the project 412 based on the example first tenant 212 not having the first authorization state data (e.g., service-provider-credentials) corresponding to the example service provider 210. In some examples, the policy management circuitry 308 may determine to grant the example first tenant 212 access based on the example cloud provider interface circuitry 302 accessing an infrastructure resource identifier from the request and comparing the identifier to infrastructure resource identifiers stored in a database to determine whether the infrastructure resource identified by the request is accessible by the first tenant 212 according to the guardrails set by the example service provider 210. In response to the example policy management circuitry 308 determining access can be granted to the example first tenant 212 (e.g., “YES”), control advances to block 1316. In response to the example policy management circuitry 308 determining access is not to be granted to the example first tenant 212 (e.g., “NO”), control advances to block 1314.

At block 1314, the permission is not granted, and the example policy management circuitry 308 denies access by sending an access denied message. For example, the service provider 210 may revoke access to the example project 412 or deny a provisioning of a specific workload based on the example first tenant 212 not having the first authorization state. The example cloud provider hub circuitry 180 which grants the first authorization state may not grant the first authorization state and deny access. Examples for the denied access include that there are incorrect credentials, an expired token, or not enough permissions (e.g., the second tenant 214 tries to access the project 412 which is provisioned to the first tenant 212). In some examples, the provisioning circuitry 160 may deny access to the provisioning request based on a determination that a requested workload requires too many cloud infrastructure resources. Control returns to block 1310 to receive another request to access the cloud infrastructure resources.

At block 1316, the example cloud provider interface circuitry 302 allows the first tenant 212 to access the selected cloud infrastructure resources assigned to the project 412 based on the tenant account 403. For example, the cloud provider interface circuitry 302 may allow the first tenant 212 access by using the example second authorization state data, which is used by the example provisioning circuitry 160 and by the example cloud provider interface circuitry 302 to represent the example first tenant 212 as the example service provider 210 to the example cloud providers 202, 204, 206. In some examples, the example first tenant 212 impersonates the example service provider 210 by using the example second authorization state data and the example cloud provider interface circuitry 302 to represent itself as the example service provider 210.

At block 1318, the example cloud provider interface circuitry 302 enumerates the cloud infrastructure resources of the service provider 210 for the first tenant 212. For example, the cloud provider interface circuitry 302 may enumerate the cloud infrastructure resources of the service provider 210 for the first tenant 212 by enumerating the service-provider-cloud-zone 1104 (FIG. 11) of the service provider 210 as a region 1116 (FIG. 11) for the first tenant 212. The cloud infrastructure resources (e.g., virtual machines, workloads) are now provisioned for access. The machine readable instructions and/or the operations 1300 end.

FIG. 14 is a flowchart representative of example machine readable instructions and/or example operations 1400 that may be executed and/or instantiated by processor circuitry to provision cloud infrastructure resources in accordance with teachings of this disclosure. The machine readable instructions and/or the operations 1400 of FIG. 14 begin at block 1401, at which the example provisioning circuitry 160 (FIG. 2) receives a tenant deployment request from the example first tenant 212 (FIG. 2). For example, an example endpoint user with an example endpoint user device 216 may submit a request for a deployment of cloud infrastructure resources as a virtual machine. In some examples, enumeration and/or provisioning is run every ten minutes, independent of being triggered by receipt of provisioning requests. For example, the provisioning circuitry 160 may refresh in a set time interval (e.g., ten minutes) and check for new provisioning requests, and if there are no provisioning requests, refresh after the set time interval passes and check for new provisioning requests a second time. During enumeration and/or provisioning, the example provisioning circuitry 160 leverages the cloud infrastructure resources that have been already discovered on the corresponding cloud zone.

At block 1402, the example cloud provider interface circuitry 302 (FIG. 3) determines to provision cloud infrastructure resources based on the tenant deployment request. For example, the example cloud provider interface circuitry 302 may determine to provision cloud infrastructure resources in response to an endpoint user submitting a request for a virtual machine via the example first endpoint user device 216 (FIG. 2).

At block 1403, the example provisioning circuitry 160 (FIG. 2) determines a cloud zone 416 to provision the cloud infrastructure resources based on the tenant deployment request. For example, the first cloud zone 416 may be selected by the example provisioning circuitry 160 for provisioning of the cloud infrastructure resources. In examples where the first cloud zone 416 (e.g., a cloud zone that corresponds to the example cloud provider interface account) is selected, the example cloud-agnostic interface adapter 228 of FIG. 2 is used to initiate the provisioning. In examples where the second cloud zone 418 (e.g., a cloud zone that corresponds to an example cloud provider account) is selected, one of the example cloud-specific adapters 222, 224, 226 corresponding to an example cloud provider 202, 204, 206 of a selected cloud provider account is used to perform the provisioning.

At block 1404, the example provisioning circuitry 160 (FIG. 2) determines the cloud account type of the cloud zone used to provision the cloud infrastructure resources. For example, the provisioning circuitry 160 may determine the cloud account type by comparing the cloud account that corresponds to the determined cloud zone (either the example first cloud zone 416 or the example second cloud zone 418) with the example provisioning database 232 (FIG. 2). For example, the example provisioning database 232 stores cloud account types in records of registered cloud accounts. In examples disclosed herein there are two cloud account types, referred to as a cloud provider interface type and a cloud provider type. In examples disclosed herein, a cloud account type which is a cloud provider interface type is a cloud account that may self-referentially access the vRealize Automation® cloud management platform 140 (FIG. 1). By accessing the vRealize Automation® cloud management platform 140, the cloud account can access the example cloud providers 202, 204, 206. In examples disclosed herein, a cloud account type which is a cloud provider type is a cloud account that refers to the example cloud providers 202, 204, 206 (e.g., VMware vSphere cloud provider, Microsoft Azure Cloud Services, Amazon Web Services (AWS), Google Cloud Platform, Alibaba Cloud, VMware vCloud Director cloud service delivery platform, etc.).

At block 1406, the example provisioning circuitry 160 determines if the cloud account type is a cloud provider interface type. For example, the provisioning circuitry 160 uses the results of block 1404 to determine whether the cloud account type is a cloud provider interface type. As used herein, if the cloud account type is not of cloud provider interface type, the cloud account type is of a cloud provider type such as the first cloud provider 202 (e.g., Amazon Web Services), the second cloud provider 204 (e.g., Google Cloud Platform), or the example third cloud provider 206 (e.g., Microsoft Azure). In response to determining that the cloud account type is not of cloud provider interface type (e.g., block 1406: “NO”), control flows to block 1418.

At block 1418, the example provisioning circuitry 160 uses the determined cloud-specific adapter 222 to start enumeration of the cloud infrastructure resources. For example, the provisioning circuitry 160 may use the example first cloud-specific adapter 222, which corresponds to the first cloud provider 202, to enumerate a subset of the cloud infrastructure resources. For example, the subset of the cloud infrastructure resources first enumerated may be the project resource 1102 (FIG. 11) and the cloud zone resource 1104 (FIG. 11). Control advances to block 1420.

In response to determining at block 1406 that the cloud account type is of type cloud provider interface (block 1406: “YES”), control advances to block 1407. In response to determining the cloud account type is cloud provider interface type, (and not a cloud provider type) the example provisioning circuitry 160 does not directly provision the cloud infrastructure resources according to the determined cloud provider type.

At block 1407, the example cloud provider interface circuitry 302 obtains service-provider-credentials. For example, the cloud provider interface circuitry 302 may obtain (e.g., access) service-provider-credentials (e.g., first authorization state data) from the example the first tenant credential database 234. Control advances to block 1408.

At block 1408, the example cloud-agnostic interface adapter 228 impersonates the service provider 210 with first authorization state data (e.g., the service-provider-credentials). For example, the cloud-agnostic interface adapter 228 may impersonate the service provider 210 to the example cloud provider hub circuitry 180 (FIG. 2). For examples, the cloud-agnostic interface adapter 228 may impersonate the service provider 210 to the example cloud provider hub circuitry 180 by using first authorization state data (e.g., username 434 of FIG. 4 is finance@enterprise.com and the password 436 of FIG. 4 is Passw0rd123). The example cloud provider hub circuitry 180 believes the example cloud-agnostic interface adapter 228 is the example service provider 210 based on the example first authorization state data.

At block 1410, the example cloud-agnostic interface adapter 228 uses the first authorization state data (e.g., access configuration data 428) to retrieve an access token from example cloud provider hub circuitry 180. For example, the cloud-agnostic interface adapter 228 may request the second authorization state data (e.g., access token) from cloud provider hub circuitry 180. Since the access token corresponds to credentials that match the credentials of the example service provider 210 in the access configuration data 428, the cloud provider hub circuitry 180 generates an access token corresponding to the service provider 210 for access of one of the example cloud providers 202, 204, 206. In some examples, the access token may be the second authorization state data corresponding to the first cloud provider 202 as described in connection in FIG. 4.

At block 1412, the example provisioning circuitry 160 requests a deployment of cloud infrastructure resources. For example, the provisioning circuitry 160 may request a deployment of cloud infrastructure resources based on the access token (e.g., example second authorization state data corresponding to the example first cloud provider 202). Since the example first tenant 212 is in possession of the access token based on the service provider credentials, the cloud infrastructure resources are deployed to a project 412 of the service provider 210.

At block 1414, the example cloud-agnostic interface adapter 228 enumerates the project 412 (e.g., the project 1102 of FIG. 11) of the service provider 210 as a cloud account 1114 (FIG. 11) for the example tenant 212. For example, the cloud-agnostic interface adapter 228 may use the first cloud-specific adapter 222 to provision the cloud infrastructure resources in the project 412. In this manner, by having access to the project 412, the example first tenant 212 also has access to the cloud infrastructure resources provisioned in the project 412.

At block 1416, the example cloud-agnostic interface adapter 228 enumerates the cloud zone of the service provider 210 as a region for the example tenant 212. For example, the cloud-agnostic interface adapter 228 may use the first cloud-specific adapter 222 to provision the cloud zone 1104 (FIG. 11) as the region 1116 (FIG. 11) for the example tenant 212, where the example tenant 212 can access the region 1116 (FIG. 11) to access the cloud zone 1104 (FIG. 11).

At block 1420, the example provisioning circuitry 160 uses the corresponding adapter for the corresponding cloud provider (e.g., the first cloud-specific adapter 222 and the first cloud provider 202 in FIG. 2) to enumerate additional cloud infrastructure resources for the example tenant 212. For example, the provisioning circuitry 160 may enumerate flavor mappings 1106 (FIG. 11) of the service provider 210, image mappings 1108 (FIG. 11) of the service provider 210, and specific exposed networks 1122 (FIG. 11) from the service-provider network profile 1110 (FIG. 11) of the service provider 210 to the example tenant 212. The instructions 1400 end.

FIG. 15 is a block diagram of an example processor platform 1500 structured to execute and/or instantiate the machine readable instructions and/or the operations of FIGS. 13-14 to implement the cloud provider circuitry 170 of FIG. 3. The processor platform 1500 can be, for example, a server, a personal computer, a workstation, a self-learning machine (e.g., a neural network, or any other type of computing device.

The processor platform 1500 of the illustrated example includes processor circuitry 1512. The processor circuitry 1512 of the illustrated example is hardware. For example, the processor circuitry 1512 can be implemented by one or more integrated circuits, logic circuits, FPGAs, microprocessors, CPUs, GPUs, DSPs, and/or microcontrollers from any desired family or manufacturer. The processor circuitry 1512 may be implemented by one or more semiconductor based (e.g., silicon based) devices. In this example, the processor circuitry 1512 implements the example cloud provider interface circuitry 302, the example tenant management circuitry 304, the example project generation circuitry 306, the example policy management circuitry 308, the example project management circuitry 310, and the example cloud provider hub circuitry 180.

The processor circuitry 1512 of the illustrated example includes a local memory 1513 (e.g., a cache, registers, etc.). The processor circuitry 1512 of the illustrated example is in communication with a main memory including a volatile memory 1514 and a non-volatile memory 1516 by a bus 1518. The volatile memory 1514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1516 may be implemented by flash memory and/or any other desired type of memory device. Access to the main memory 1514, 1516 of the illustrated example is controlled by a memory controller 1517.

The processor platform 1500 of the illustrated example also includes interface circuitry 1520. The interface circuitry 1520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1522 are connected to the interface circuitry 1520. The input device(s) 1522 permit(s) a user to enter data and/or commands into the processor circuitry 1512. The input device(s) 1522 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1524 are also connected to the interface circuitry 1520 of the illustrated example. The output device(s) 1524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1520 of the illustrated example, thus, typically includes a graphics driver card, a graphics driver chip, and/or graphics processor circuitry such as a GPU.

The interface circuitry 1520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1526. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1500 of the illustrated example also includes one or more mass storage devices 1528 to store software and/or data. The one or more mass storage devices 1528 include the cloud credential database 230, the provisioning database 232, the first tenant credential database 234, and the second tenant credential database 236. Examples of such mass storage devices 1528 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 1532, which may be implemented by the machine readable instructions of FIGS. 13-14, may be stored in the mass storage device 1528, in the volatile memory 1514, in the non-volatile memory 1516, and/or on a removable non-transitory computer readable storage medium such as a CD or DVD.

FIG. 16 is a block diagram of an example implementation of the processor circuitry 1512 of FIG. 15. In this example, the processor circuitry 1512 of FIG. 15 is implemented by a general purpose microprocessor 1600. The general purpose microprocessor circuitry 1600 executes some or all of the machine readable instructions of the flowcharts of FIGS. 13-14 to effectively instantiate the circuitry of FIG. 3 as logic circuits to perform the operations corresponding to those machine readable instructions. In some such examples, the circuitry of FIG. 3, cloud provider circuitry 170 is instantiated by the hardware circuits of the microprocessor 1600 in combination with the instructions. For example, the microprocessor 1600 may implement multi-core hardware circuitry such as a CPU, a DSP, a GPU, an XPU, etc. Although it may include any number of example cores 1602 (e.g., 1 core), the microprocessor 1600 of this example is a multi-core semiconductor device including N cores. The cores 1602 of the microprocessor 1600 may operate independently or may cooperate to execute machine readable instructions. For example, machine code corresponding to a firmware program, an embedded software program, or a software program may be executed by one of the cores 1602 or may be executed by multiple ones of the cores 1602 at the same or different times. In some examples, the machine code corresponding to the firmware program, the embedded software program, or the software program is split into threads and executed in parallel by two or more of the cores 1602. The software program may correspond to a portion or all of the machine readable instructions and/or operations represented by the flowcharts of FIGS. 13-14.

The cores 1602 may communicate by a first example bus 1604. In some examples, the first bus 1604 may implement a communication bus to effectuate communication associated with one(s) of the cores 1602. For example, the first bus 1604 may implement at least one of an Inter-Integrated Circuit (I2C) bus, a Serial Peripheral Interface (SPI) bus, a PCI bus, or a PCIe bus. Additionally or alternatively, the first bus 1604 may implement any other type of computing or electrical bus. The cores 1602 may obtain data, instructions, and/or signals from one or more external devices by example interface circuitry 1606. The cores 1602 may output data, instructions, and/or signals to the one or more external devices by the interface circuitry 1606. Although the cores 1602 of this example include example local memory 1620 (e.g., Level 1 (L1) cache that may be split into an L1 data cache and an L1 instruction cache), the microprocessor 1600 also includes example shared memory 1610 that may be shared by the cores (e.g., Level 2 (L2_ cache)) for high-speed access to data and/or instructions. Data and/or instructions may be transferred (e.g., shared) by writing to and/or reading from the shared memory 1610. The local memory 1620 of each of the cores 1602 and the shared memory 1610 may be part of a hierarchy of storage devices including multiple levels of cache memory and the main memory (e.g., the main memory 1514, 1516 of FIG. 15). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1602 may be referred to as a CPU, DSP, GPU, etc., or any other type of hardware circuitry. Each core 1602 includes control unit circuitry 1614, arithmetic and logic (AL) circuitry (sometimes referred to as an ALU) 1616, a plurality of registers 1618, the L1 cache 1620, and a second example bus 1622. Other structures may be present. For example, each core 1602 may include vector unit circuitry, single instruction multiple data (SIMD) unit circuitry, load/store unit (LSU) circuitry, branch/jump unit circuitry, floating-point unit (FPU) circuitry, etc. The control unit circuitry 1614 includes semiconductor-based circuits structured to control (e.g., coordinate) data movement within the corresponding core 1602. The AL circuitry 1616 includes semiconductor-based circuits structured to perform one or more mathematic and/or logic operations on the data within the corresponding core 1602. The AL circuitry 1616 of some examples performs integer based operations. In other examples, the AL circuitry 1616 also performs floating point operations. In yet other examples, the AL circuitry 1616 may include first AL circuitry that performs integer based operations and second AL circuitry that performs floating point operations. In some examples, the AL circuitry 1616 may be referred to as an Arithmetic Logic Unit (ALU). The registers 1618 are semiconductor-based structures to store data and/or instructions such as results of one or more of the operations performed by the AL circuitry 1616 of the corresponding core 1602. For example, the registers 1618 may include vector register(s), SIMD register(s), general purpose register(s), flag register(s), segment register(s), machine specific register(s), instruction pointer register(s), control register(s), debug register(s), memory management register(s), machine check register(s), etc. The registers 1618 may be arranged in a bank as shown in FIG. 16. Alternatively, the registers 1618 may be organized in any other arrangement, format, or structure including distributed throughout the core 1602 to shorten access time. The second bus 1622 may implement at least one of an I2C bus, a SPI bus, a PCI bus, or a PCIe bus

Each core 1602 and/or, more generally, the microprocessor 1600 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1600 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

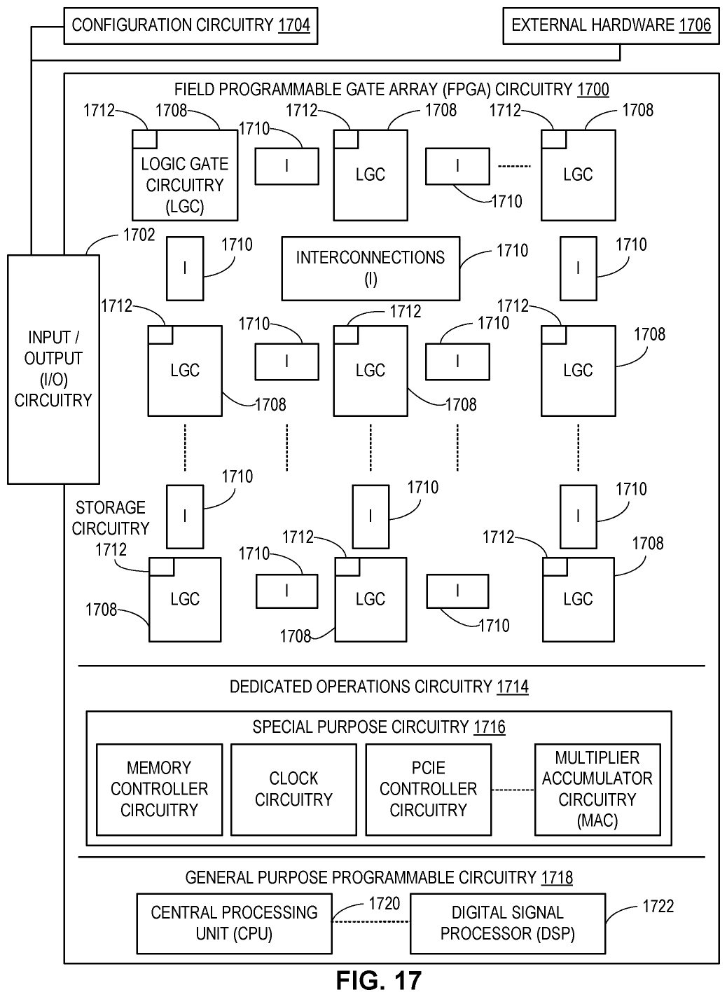

FIG. 17 is a block diagram of another example implementation of the processor circuitry 1512 of FIG. 15. In this example, the processor circuitry 1512 is implemented by FPGA circuitry 1700. The FPGA circuitry 1700 can be used, for example, to perform operations that could otherwise be performed by the example microprocessor 1600 of FIG. 16 executing corresponding machine readable instructions. However, once configured, the FPGA circuitry 1700 instantiates the machine readable instructions in hardware and, thus, can often execute the operations faster than they could be performed by a general purpose microprocessor executing the corresponding software.

More specifically, in contrast to the microprocessor 1700 of FIG. 17 described above (which is a general purpose device that may be programmed to execute some or all of the machine readable instructions represented by the flowcharts of FIGS. 13-14 but whose interconnections and logic circuitry are fixed once fabricated), the FPGA circuitry 1700 of the example of FIG. 17 includes interconnections and logic circuitry that may be configured and/or interconnected in different ways after fabrication to instantiate, for example, some or all of the machine readable instructions represented by the flowcharts of FIGS. 13-14. In particular, the FPGA 1700 may be thought of as an array of logic gates, interconnections, and switches. The switches can be programmed to change how the logic gates are interconnected by the interconnections, effectively forming one or more dedicated logic circuits (unless and until the FPGA circuitry 1700 is reprogrammed). The configured logic circuits enable the logic gates to cooperate in different ways to perform different operations on data received by input circuitry. Those operations may correspond to some or all of the software represented by the flowcharts of FIGS. 13-14. As such, the FPGA circuitry 1700 may be structured to effectively instantiate some or all of the machine readable instructions of the flowcharts of FIGS. 13-14 as dedicated logic circuits to perform the operations corresponding to those software instructions in a dedicated manner analogous to an ASIC. Therefore, the FPGA circuitry 1700 may perform the operations corresponding to the some or all of the machine readable instructions of FIGS. 13-14 faster than the general purpose microprocessor can execute the same.

In the example of FIG. 17, the FPGA circuitry 1700 is structured to be programmed (and/or reprogrammed one or more times) by an end user by a hardware description language (HDL) such as Verilog. The FPGA circuitry 1700 of FIG. 17, includes example input/output (I/O) circuitry 1702 to obtain and/or output data to/from example configuration circuitry 1704 and/or external hardware (e.g., external hardware circuitry) 1706. For example, the configuration circuitry 1704 may implement interface circuitry that may obtain machine readable instructions to configure the FPGA circuitry 1700, or portion(s) thereof. In some such examples, the configuration circuitry 1704 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1706 may implement the microprocessor 1700 of FIG. 17. The FPGA circuitry 1700 also includes an array of example logic gate circuitry 1708, a plurality of example configurable interconnections 1710, and example storage circuitry 1712. The logic gate circuitry 1708 and interconnections 1710 are configurable to instantiate one or more operations that may correspond to at least some of the machine readable instructions of FIGS. 13-14 and/or other desired operations. The logic gate circuitry 1708 shown in FIG. 17 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1708 to enable configuration of the electrical structures and/or the logic gates to form circuits to perform desired operations. The logic gate circuitry 1708 may include other electrical structures such as look-up tables (LUTs), registers (e.g., flip-flops or latches), multiplexers, etc.

The interconnections 1710 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1708 to program desired logic circuits.

The storage circuitry 1712 of the illustrated example is structured to store result(s) of the one or more of the operations performed by corresponding logic gates. The storage circuitry 1712 may be implemented by registers or the like. In the illustrated example, the storage circuitry 1712 is distributed amongst the logic gate circuitry 1708 to facilitate access and increase execution speed.

The example FPGA circuitry 1700 of FIG. 17 also includes example Dedicated Operations Circuitry 1714. In this example, the Dedicated Operations Circuitry 1714 includes special purpose circuitry 1716 that may be invoked to implement commonly used functions to avoid the need to program those functions in the field. Examples of such special purpose circuitry 1716 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1700 may also include example general purpose programmable circuitry 1718 such as an example CPU 1720 and/or an example DSP 1722. Other general purpose programmable circuitry 1718 may additionally or alternatively be present such as a GPU, an XPU, etc., that can be programmed to perform other operations.

Although FIGS. 16 and 17 illustrate two example implementations of the processor circuitry 1512 of FIG. 15, many other approaches are contemplated. For example, as mentioned above, modern FPGA circuitry may include an on-board CPU, such as one or more of the example CPU 1720 of FIG. 17. Therefore, the processor circuitry 1512 of FIG. 15 may additionally be implemented by combining the example microprocessor 1600 of FIG. 16 and the example FPGA circuitry 1700 of FIG. 17. In some such hybrid examples, a first portion of the machine readable instructions represented by the flowcharts of FIGS. 13-14 may be executed by one or more of the cores 1602 of FIG. 16, a second portion of the machine readable instructions represented by the flowcharts of FIGS. 13-14 may be executed by the FPGA circuitry 1700 of FIG. 17, and/or a third portion of the machine readable instructions represented by the flowcharts of FIGS. 13-14 may be executed by an ASIC. It should be understood that some or all of the circuitry of FIG. 3 may, thus, be instantiated at the same or different times. Some or all of the circuitry may be instantiated, for example, in one or more threads executing concurrently and/or in series. Moreover, in some examples, some or all of the circuitry of FIG. 3 may be implemented within one or more virtual machines and/or containers executing on the microprocessor.

In some examples, the processor circuitry 1512 of FIG. 15 may be in one or more packages. For example, the processor circuitry 1600 of FIG. 16 and/or the FPGA circuitry 1700 of FIG. 17 may be in one or more packages. In some examples, an XPU may be implemented by the processor circuitry 1512 of FIG. 15, which may be in one or more packages. For example, the XPU may include a CPU in one package, a DSP in another package, a GPU in yet another package, and an FPGA in still yet another package.

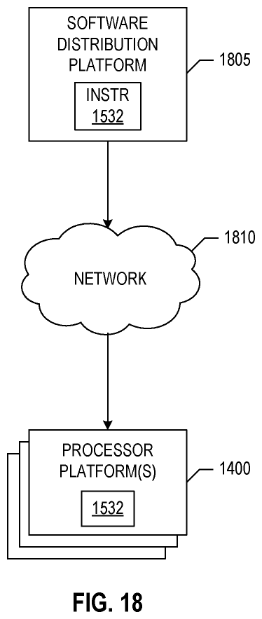

A block diagram illustrating an example software distribution platform 1805 to distribute software such as the example machine readable instructions 1532 of FIG. 15 to hardware devices owned and/or operated by third parties is illustrated in FIG. 18. The example software distribution platform 1805 may be implemented by any computer server, data facility, cloud service, etc., capable of storing and transmitting software to other computing devices. The third parties may be customers of the entity owning and/or operating the software distribution platform 1805. For example, the entity that owns and/or operates the software distribution platform 1805 may be a developer, a seller, and/or a licensor of software such as the example machine readable instructions 1532 of FIG. 15. The third parties may be consumers, users, retailers, OEMs, etc., who purchase and/or license the software for use and/or re-sale and/or sub-licensing. In the illustrated example, the software distribution platform 1805 includes one or more servers and one or more storage devices. The storage devices store the machine readable instructions 1532, which may correspond to the example machine readable instructions 1400 of FIG. 14, as described above. The one or more servers of the example software distribution platform 1805 are in communication with a network 1810, which may correspond to any one or more of the Internet and/or any of the example networks 1526 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1532 from the software distribution platform 1805. For example, the software, which may correspond to the example machine readable instructions 1532 of FIG. 15, may be downloaded to the example processor platform 1500, which is to execute the machine readable instructions 1532 to implement the cloud provider circuitry 170 of FIGS. 1 and 2. In some example, one or more servers of the software distribution platform 1805 periodically offer, transmit, and/or force updates to the software (e.g., the example machine readable instructions 1532 of FIG. 15) to ensure improvements, patches, updates, etc., are distributed and applied to the software at the end user devices.

From the foregoing, it will be appreciated that example systems, methods, apparatus, and articles of manufacture have been disclosed that provision cloud infrastructure resources. Disclosed systems, methods, apparatus, and articles of manufacture improve the efficiency of using a computing device by allowing cloud infrastructure resources to be shared which reduces wasting resources by requiring a new compute machine for each endpoint user. The disclosed systems, methods, apparatus, and articles of manufacture improve the efficiency of a computing device by allowing an endpoint user to provision virtual machines on specific cloud providers by using a cloud provider interface account without requiring the endpoint user to have a specific cloud provider account for each of the specific cloud providers. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to for sharing cloud resources in a multi-tenant system using self-referencing adapter are disclosed herein.

Further Examples and Combinations Thereof Include the Following:

Example 1 includes an apparatus to provision cloud infrastructure resources, the apparatus comprising provisioning circuitry to, in response to a first request from a tenant to access cloud infrastructure resources, determine a type of a cloud account, cloud provider interface circuitry to, in response to the type of the cloud account being a cloud provider interface type, access service-provider-credentials, the cloud provider interface circuitry to retrieve a first access token based on the service-provider-credentials, submit a second request for the cloud infrastructure resources to a first cloud provider, the second request corresponding to the tenant impersonating the service provider based on the first access token.

Example 2 includes the apparatus of example 1, wherein the provisioning circuitry is to provision the cloud infrastructure resources corresponding to the first cloud provider based on the second request.

Example 3 includes the apparatus of example 1, wherein the provisioning circuitry is to at least one of (a) enumerate a service-provider-project as a cloud account for the tenant, or (b) enumerate a service-provider-cloud-zone as a region for the tenant.

Example 4 includes the apparatus of example 1, further including tenant management circuitry to generate a tenant account corresponding to the tenant, the tenant account including resource permissions to allow the tenant to (a) access the cloud infrastructure resources from the first cloud provider, and (b) impersonate the service provider to access the cloud infrastructure resources provided by the first cloud provider.

Example 5 includes the apparatus of example 4, further including project generation circuitry to assign the cloud infrastructure resources and the tenant account to a project, the project to be used by the tenant account to deploy the cloud infrastructure resources.

Example 6 includes the apparatus of example 5, further including policy management circuitry to grant the tenant access to the cloud infrastructure resources assigned to the project based on the tenant account and based on the tenant impersonating the service provider.

Example 7 includes the apparatus of example 1, further including policy management circuitry to generate a policy corresponding to tenant access, and store a restriction setting in the policy to prevent the tenant from modifying constraints of the cloud infrastructure resource.

Example 8 includes the apparatus of example 1, wherein the cloud provider interface circuitry is to select the cloud infrastructure resources in response to the provisioning circuitry receiving a third request.

Example 9 includes the apparatus of example 1, further including tenant management circuitry to generate a tenant account based on access data, the access data including at least one of an address of a cloud provider account, an organization identification, a project identification, or user credentials, the user credentials including a username of the cloud provider account of the service provider, and a password of the cloud provider account of the service provider.

Example 10 includes the apparatus of example 9, wherein the tenant management circuitry is to use the user credentials to access the cloud infrastructure resources.

Example 11 includes the apparatus of example 1, further including project management circuitry to store a resource tag in a record in association with the cloud infrastructure resource, and bill the tenant based on the resource tag for accessing the cloud infrastructure resource.

Example 12 includes the apparatus of example 11, wherein the project management circuitry is to resource-tag the cloud infrastructure resources to facilitate resource management and billing.

Example 13 includes a non-transitory computer readable medium comprising instructions that, when executed, cause processor circuitry to at least in response to a first request from a tenant to access cloud infrastructure resources, determine a type of a cloud account, in response to the type of the cloud account being a cloud provider interface type, access service-provider-credentials, retrieve a first access token based on the service-provider-credentials, submit a second request for the cloud infrastructure resources to a first cloud provider, the second request corresponding to the tenant impersonating the service provider based on the first access token.

Example 14 includes the non-transitory computer readable medium of example 13, wherein the processor circuitry is to provision the cloud infrastructure resources corresponding to the first cloud provider based on the second request.

Example 15 includes the non-transitory computer readable medium of example 13, wherein the processor circuitry is to at least one of (a) enumerate a service-provider-project as a cloud account for the tenant, or (b) enumerate a service-provider-cloud-zone as a region for the tenant.

Example 16 includes the non-transitory computer readable medium of example 13, wherein the processor circuitry is to generate a tenant account corresponding to the tenant, the tenant account including resource permissions to allow the tenant to (a) access the cloud infrastructure resources from the first cloud provider, and (b) impersonate the service provider to access the cloud infrastructure resources provided by the first cloud provider.

Example 17 includes the non-transitory computer readable medium of example 16, wherein the processor circuitry is to assign the cloud infrastructure resources and the tenant account to a project, the project to be used by the tenant account to deploy the cloud infrastructure resources.

Example 18 includes the non-transitory computer readable medium of example 17, wherein the processor circuitry to grant the tenant access to the cloud infrastructure resources assigned to the project based on the tenant account and based on the tenant impersonating the service provider.

Example 19 includes the non-transitory computer readable medium of example 13, wherein the processor circuitry is further to generate a policy corresponding to tenant access, and store a restriction setting in the policy to prevent the tenant from modifying constraints of the cloud infrastructure resource.

Example 20 includes the non-transitory computer readable medium of example 13, wherein the processor circuitry is to select the cloud infrastructure resources in response to the processor circuitry receiving a third request.

Example 21 includes the non-transitory computer readable medium of example 13, wherein the processor circuitry is to generate a tenant account based on access data, the access data including at least one of an address of a cloud provider account, an organization identification, a project identification, or user credentials, the user credentials including a username of the cloud provider account of the service provider, and a password of the cloud provider account of the service provider.

Example 22 includes the non-transitory computer readable medium of example 21, wherein the processor circuitry is to use the user credentials to access the cloud infrastructure resources.

Example 23 includes the non-transitory computer readable medium of example 13, wherein the processor circuitry is to store a resource tag in a record in association with the cloud infrastructure resource, and bill the tenant based on the resource tag for accessing the cloud infrastructure resource.

Example 24 includes the non-transitory computer readable medium of example 23, wherein the processor circuitry is to resource-tag the cloud infrastructure resources to facilitate resource management and billing.

Example 25 includes a method to provision cloud infrastructure resources, the method comprising in response to a first request from a tenant to access cloud infrastructure resources, determining a type of a cloud account based on the cloud zone, in response to the type of the cloud account being a cloud provider interface type, accessing service-provider-credentials, retrieving a first access token based on the service-provider-credentials, submitting a second request for the cloud infrastructure resources to a first cloud provider, the second request corresponding to the tenant impersonating the service provider based on the first access token.

Example 26 includes the method of example 25, further including provisioning the cloud infrastructure resources corresponding to a first cloud provider based on the second request.

Example 27 includes the method of example 25, further including at least one of (a) enumerating a service-provider-project as a cloud account for the tenant, or (b) enumerating a service-provider-cloud-zone as a region for the tenant.

Example 28 includes the method of example 25, further including generating a tenant account corresponding to the tenant, the tenant account including resource permissions to allow the tenant to (a) access the cloud infrastructure resources from the first cloud provider, and (b) impersonate the service provider to access the cloud infrastructure resources provided by the first cloud provider.

Example 29 includes the method of example 28, further including assigning the cloud infrastructure resources and the tenant account to a project, the project to be used by the tenant account to deploy the cloud infrastructure resources.

Example 30 includes the method of example 29, further including granting the tenant access to the cloud infrastructure resources assigned to the project based on the tenant account and based on the tenant impersonating the service provider.

Example 31 includes the method of example 25, further including generating a policy corresponding to tenant access, and storing a restriction setting in the policy to prevent the tenant from modifying constraints of the cloud infrastructure resource.

Example 32 includes the method of example 25, further including selecting the cloud infrastructure resources in response to the provisioning circuitry receiving a third request.

Example 33 includes the method of example 25, further including generating a tenant account based on access data, the access data including at least one of an address of a cloud provider account, an organization identification, a project identification, or user credentials, the user credentials including a username of the cloud provider account of the service provider, and a password of the cloud provider account of the service provider.

Example 34 includes the method of example 25, further including using the user credentials to access the cloud infrastructure resources.

Example 35 includes the method of example 34, further including storing a resource tag in a record in association with the cloud infrastructure resource, and billing the tenant based on the resource tag for accessing the cloud infrastructure resource.

Example 36 includes the method of example 25, further including resource-tagging the cloud infrastructure resources to facilitate resource management and billing.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus to provision cloud infrastructure resources, the apparatus comprising:
provisioning circuitry to, in response to a first request from a tenant to access cloud infrastructure resources, determine a type of a cloud account;
cloud provider interface circuitry to, in response to the type of the cloud account being a cloud provider interface type, access service-provider-credentials;
the cloud provider interface circuitry to:
retrieve a first access token based on the service-provider-credentials;
submit a second request for the cloud infrastructure resources to a first cloud provider, the second request corresponding to the tenant impersonating the service provider based on the first access token.

2. The apparatus of claim 1, wherein the provisioning circuitry is to provision the cloud infrastructure resources corresponding to the first cloud provider based on the second request.

3. The apparatus of claim 1, wherein the provisioning circuitry is to at least one of: (a) enumerate a service-provider-project as a cloud account for the tenant, or (b) enumerate a service-provider-cloud-zone as a region for the tenant.

4. The apparatus of claim 1, further including tenant management circuitry to generate a tenant account corresponding to the tenant, the tenant account including resource permissions to allow the tenant to: (a) access the cloud infrastructure resources from the first cloud provider, and (b) impersonate the service provider to access the cloud infrastructure resources provided by the first cloud provider.

5. The apparatus of claim 4, further including project generation circuitry to assign the cloud infrastructure resources and the tenant account to a project, the project to be used by the tenant account to deploy the cloud infrastructure resources.

6. The apparatus of claim 5, further including policy management circuitry to grant the tenant access to the cloud infrastructure resources assigned to the project based on the tenant account and based on the tenant impersonating the service provider.

7. The apparatus of claim 1, further including policy management circuitry to:
generate a policy corresponding to tenant access; and
store a restriction setting in the policy to prevent the tenant from modifying constraints of the cloud infrastructure resource.

8. The apparatus of claim 1, wherein the cloud provider interface circuitry is to select the cloud infrastructure resources in response to the provisioning circuitry receiving a third request.

9. The apparatus of claim 1, further including tenant management circuitry to generate a tenant account based on access data, the access data including at least one of an address of a cloud provider account, an organization identification, a project identification, or user credentials, the user credentials including a username of the cloud provider account of the service provider, and a password of the cloud provider account of the service provider.

10. The apparatus of claim 9, wherein the tenant management circuitry is to use the user credentials to access the cloud infrastructure resources.

11. The apparatus of claim 1, further including project management circuitry to:
store a resource tag in a record in association with the cloud infrastructure resource; and
bill the tenant based on the resource tag for accessing the cloud infrastructure resource.

12. (canceled)

13. A non-transitory computer readable medium comprising instructions that, when executed, cause processor circuitry to at least:
in response to a first request from a tenant to access cloud infrastructure resources, determine a type of a cloud account;
in response to the type of the cloud account being a cloud provider interface type, access service-provider-credentials;
retrieve a first access token based on the service-provider-credentials;
submit a second request for the cloud infrastructure resources to a first cloud provider, the second request corresponding to the tenant impersonating the service provider based on the first access token.

14. The non-transitory computer readable medium of claim 13, wherein the processor circuitry is to provision the cloud infrastructure resources corresponding to the first cloud provider based on the second request.

15. The non-transitory computer readable medium of claim 13, wherein the processor circuitry is to at least one of: (a) enumerate a service-provider-project as a cloud account for the tenant, or (b) enumerate a service-provider-cloud-zone as a region for the tenant.

16. The non-transitory computer readable medium of claim 13, wherein the processor circuitry is to generate a tenant account corresponding to the tenant, the tenant account including resource permissions to allow the tenant to: (a) access the cloud infrastructure resources from the first cloud provider, and (b) impersonate the service provider to access the cloud infrastructure resources provided by the first cloud provider.

17. The non-transitory computer readable medium of claim 16, wherein the processor circuitry is to assign the cloud infrastructure resources and the tenant account to a project, the project to be used by the tenant account to deploy the cloud infrastructure resources.

18. The non-transitory computer readable medium of claim 17, wherein the processor circuitry to grant the tenant access to the cloud infrastructure resources assigned to the project based on the tenant account and based on the tenant impersonating the service provider.

19. The non-transitory computer readable medium of claim 13, wherein the processor circuitry is further to:
generate a policy corresponding to tenant access; and
store a restriction setting in the policy to prevent the tenant from modifying constraints of the cloud infrastructure resource.

20. The non-transitory computer readable medium of claim 13, wherein the processor circuitry is to select the cloud infrastructure resources in response to the processor circuitry receiving a third request.

21. The non-transitory computer readable medium of claim 13, wherein the processor circuitry is to generate a tenant account based on access data, the access data including at least one of an address of a cloud provider account, an organization identification, a project identification, or user credentials, the user credentials including a username of the cloud provider account of the service provider, and a password of the cloud provider account of the service provider.

22. The non-transitory computer readable medium of claim 21, wherein the processor circuitry is to use the user credentials to access the cloud infrastructure resources.

23. The non-transitory computer readable medium of claim 13, wherein the processor circuitry is to:
store a resource tag in a record in association with the cloud infrastructure resource; and
bill the tenant based on the resource tag for accessing the cloud infrastructure resource.

24. The non-transitory computer readable medium of claim 23, wherein the processor circuitry is to resource-tag the cloud infrastructure resources to facilitate resource management and billing.

25. A method to provision cloud infrastructure resources, the method comprising:
in response to a first request from a tenant to access cloud infrastructure resources, determining a type of a cloud account based on the cloud zone;
in response to the type of the cloud account being a cloud provider interface type, accessing service-provider-credentials;
retrieving a first access token based on the service-provider-credentials;
submitting a second request for the cloud infrastructure resources to a first cloud provider, the second request corresponding to the tenant impersonating the service provider based on the first access token.

26. The method of claim 25, further including provisioning the cloud infrastructure resources corresponding to a first cloud provider based on the second request.

27-36. (canceled)
